(19) United States
(12) Patent Application Publication
(10) Pub. No.: US 2025/0026959 A1
(43) Pub. Date: Jan. 23, 2025

(54) COMPOUND, COMPOSITION, SURFACE TREATMENT AGENT, ARTICLE, AND METHOD OF PRODUCING ARTICLE

(71) Applicant: AGC Inc., Tokyo (JP)

(72) Inventors: Motoshi AOYAMA, Tokyo (JP); Koki WATANABE, Tokyo (JP); Yasuhiro HIRATA, Tokyo (JP); Hironobu SAKAGUCHI, Tokyo (JP); Eiichiro ANRAKU, Tokyo (JP); Shiori KAWAKAMI, Tokyo (JP)

(73) Assignee: AGC Inc., Tokyo (JP)

(21) Appl. No.: 18/894,110

(22) Filed: Sep. 24, 2024

Related U.S. Application Data
(63) Continuation of application No. PCT/JP2023/008164, filed on Mar. 3, 2023.

(30) Foreign Application Priority Data
Mar. 24, 2022 (JP) 2022-049062

(51) Int. Cl. C09D 183/14; C08G 77/50; C09D 5/16; G02B 1/04

(52) U.S. Cl. CPC C09D 183/14; C08G 77/50; C09D 5/1675; G02B 1/04

(57) ABSTRACT

A compound including an alkyl group having two or more carbon atoms, an organopolysiloxane residue, and a reactive silyl group, and an application thereof.

### CROSS-REFERENCE TO RELATED APPLICATION

This application is a Continuation of International Application No. PCT/JP2023/008164, filed Mar. 3, 2023, which claims priority to Japanese Patent Application No. 2022-049062 filed Mar. 24, 2022. Each of the above applications is hereby expressly incorporated by reference, in its entirety, into the present application.

### TECHNICAL FIELD

The present disclosure relates to a compound, a composition, a surface treatment agent, an article, and a method of producing an article.

### BACKGROUND ART

In recent years, in order to improve performance such as appearance and visibility, a technique for making it difficult for a fingerprint to adhere to a surface of an article and a technique for making it easy to remove stains are required. As a specific method, a method of performing a surface treatment on a surface of an article using a surface treatment agent is known.

For example, Patent Literature 1 describes a film containing a polydialkylsiloxane skeleton. Patent Literature 2 describes a composition containing an organosilicon compound having at least one trialkylsilyl group and two or more hydrolyzable silicon groups, and a metal compound in which at least one hydrolyzable group is bonded to a metal atom.

### CITATION LIST

### Patent Literature

Patent Literature 1: Japanese Patent Application Laid-Open (JP-A) No. 2017-201010
Patent Literature 2: Japanese Patent Application Laid-Open (JP-A) No. 2017-119849

### SUMMARY OF INVENTION

### Technical Problem

Compositions used for surface treatment agents and the like are required to be further improved from the viewpoint of water repellency and abrasion resistance.

The present disclosure has been made in view of such circumstances, and an object of an embodiment of the present invention is to provide a novel compound and composition useful as a surface treatment agent capable of forming a surface treatment layer excellent in water repellency and abrasion resistance on a substrate.

An object of an embodiment of the present invention is to provide a surface treatment agent capable of forming a surface treatment layer excellent in water repellency and abrasion resistance on a substrate.

An object of an embodiment of the present invention is to provide an article having a surface treatment layer excellent in water repellency and abrasion resistance, and a method of producing the article.

### Solution to Problem

The present disclosure includes the following aspects.

<1>

A compound containing an alkyl group having two or more carbon atoms, an organopolysiloxane residue, and a reactive silyl group.

<2>

The compound according to <1>, wherein the number of the reactive silyl group is two or more.

<3>

The compound according to <1> or <2>, which is represented by the following Formula 1.

(T-Z)ₚA(Si(R¹)ₙL₃₋ₙ)_{q} (1)

In Formula 1, T represents an alkyl group having two or more carbon atoms, Z represents a divalent organopolysiloxane residue, A represents a single bond or a (p+q)-valent linking group, each Rⁱ independently represents a monovalent hydrocarbon group, each L independently represents a hydrolyzable group or a hydroxyl group, n is an integer from 0 to 2, and each of p and q each independently represents an integer of one or more.

<4>

The compound according to <3>, wherein T represents an alkyl group having 4 to 22 carbon atoms.

<5>

The compound according to <3> or <4>, wherein Z is represented by the following Formula B1.

In Formula B1, each R³ independently represents a hydrocarbon group, and k1 is an integer of one or more.

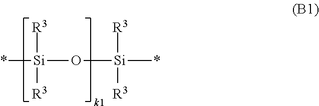

<6>

The compound according to <5>, wherein k1 is from 3 to 500 in Formula B1.

<7>

A composition including the compound according to any one of <1> to <6> and a liquid medium.

<8>

A surface treatment agent including the compound according to any one of <1> to <6>.

<9>

A surface treatment agent including the compound according to any one of <1> to <6> and a liquid medium.

<10>

The surface treatment agent according to <8> or <9>, the surface treatment agent being used for an optical member.

<11>

A method of producing an article, the method including: subjecting a substrate to a surface treatment with the surface treatment agent according to <8> or <9> to produce an article having a surface treatment layer formed on the substrate.

<12>

An article including: a substrate; and a surface treatment layer disposed on the substrate and surface-treated with the surface treatment agent according to <8>.

<13>

The article according to <12>, the article being an optical member.

<14>

The article according to <12>, the article being a display or a touch panel.

### ADVANTAGEOUS EFFECTS OF INVENTION

An embodiment of the present invention provides a novel compound and composition useful as a surface treatment agent capable of forming a surface treatment layer excellent in water repellency and abrasion resistance on a substrate.

An embodiment of the present invention provides a surface treatment agent capable of forming a surface treatment layer excellent in water repellency and abrasion resistance on a substrate.

An embodiment of the present invention provides an article having a surface treatment layer excellent in water repellency and abrasion resistance and a method of producing the article.

### DESCRIPTION OF EMBODIMENTS

In the present description, the numerical range indicated using “to” includes the numerical values described before and after “to” as the minimum value and the maximum value, respectively.

In the numerical ranges described in stages in the present description, the upper limit value or the lower limit value described in one numerical range may be replaced with the upper limit value or the lower limit value of the numerical range described in another stage. In addition, in the numerical range described in the present description, the upper limit value or the lower limit value of the numerical range may be replaced with a value shown in Examples.

In the present description, the “surface treatment layer” means a layer formed on the surface of the substrate by surface treatment.

In the present description, when a compound or group is represented by a specific Formula (X), the compound or group represented by the Formula (X) may be referred to as a Compound (X) or a Compound X, and a Group (X) or a Group X, respectively.

### [Compound]

The compound of the present disclosure contains an alkyl group having two or more carbon atoms, an organopolysiloxane residue, and a reactive silyl group.

When the compound of the disclosure is used as a surface treatment agent, a surface treatment agent excellent in water repellency and abrasion resistance can be formed. The reason for this is not clear, but is presumed as follows.

In the compound of the disclosure, containing a reactive silyl group allows high adhesion to the substrate to form a surface treatment layer on a substrate. Containing an alkyl group causes the alkyl groups to form a packing structure, and thus abrasion resistance can be imparted. Containing a polysiloxane residue can impart water repellency.

The compounds described in Patent Literature 1 and Patent Literature 2 have a divalent organopolysiloxane residue, but do not contain an alkyl group, and thus it is considered that the abrasion resistance of the surface treatment layer is insufficient for use as a surface treatment agent.

Hereinafter, the compound of the disclosure will be described in detail.

### (Alkyl Group)

The compound of the disclosure contains an alkyl group having two or more carbon atoms.

The alkyl group means an unsubstituted alkyl group. The alkyl group may be any of a linear alkyl group, a branched alkyl group, and a cyclic alkyl group, and is preferably a linear alkyl group or a branched alkyl group. The number of carbon atoms in the alkyl group is preferably from 2 to 30, more preferably from 3 to 28, and still more preferably from 4 to 22.

The compound may contain only one alkyl group or two or more alkyl groups.

The alkyl group is a monovalent group, and thus is located at the terminal of the compound.

### (Reactive Silyl Group)

The compound of the disclosure includes a reactive silyl group. The reactive silyl group is located at the terminal of the compound.

The reactive silyl group means a group in which a reactive group is bonded to a Si atom. The reactive group is preferably a hydrolyzable group or a hydroxyl group.

The hydrolyzable group is a group that becomes a hydroxyl group by a hydrolysis reaction. That is, the hydrolyzable silyl group represented by Si-L undergoes a hydrolysis reaction to become a silanol group represented by Si—OH. The silanol group further react between the silanol groups to form a Si—O—Si bond. The silanol group undergoes dehydration condensation reaction with a silanol group derived from an oxide present on the surface of the substrate to allow forming a Si—O—Si bond. Examples of the hydrolyzable group include an alkoxy group, an aryloxy group, a halogen atom, an acyl group, an acyloxy group, and an isocyanato group (—NCO). The alkoxy group is preferably an alkoxy group having 1 to 4 carbon atoms. However, examples of the aryl group of the aryloxy group includes a heteroaryl group. The halogen atom is preferably a chlorine atom. The acyl group is preferably an acyl group having 1 to 6 carbon atoms. The acyloxy group is preferably an acyloxy group having 1 to 6 carbon atoms.

From the viewpoint of easy preparation of a uniform film and excellent durability, the reactive silyl group is preferably an alkoxysilyl group or a trichlorosilyl group. The reactive silyl group is more preferably an alkoxysilyl group from the viewpoint of easy handling of by-products generated in the reaction with the substrate. The alkoxysilyl group is preferably a dialkoxysilyl group or a trialkoxysilyl group, and more preferably a trialkoxysilyl group.

The number of the reactive silyl groups contained in the compound of the disclosure is one or more, and is preferably two or more from the viewpoint of further improving the abrasion resistance of the surface treatment layer. The number of the reactive silyl groups is preferably from 1 to 18, more preferably from 2 to 12, and still more preferably from 2 to 8. The number of the reactive silyl groups may be one.

The reactive silyl group is preferably a group represented by the following Formula A.

—Si(R¹)ₙL₃₋ₙ (A)

Each Rⁱ independently represents a hydrocarbon group, L independently represents a hydrolyzable group or a hydroxyl group, and n represents an integer from 0 to 2.

In a case where there is a plurality of the reactive silyl groups in one molecule, the plurality of the reactive silyl groups may be the same or different from each other. The plurality of the reactive silyl groups are preferably the same from the viewpoint of availability of raw materials and ease of production of the compound.

Each R¹ independently represents a hydrocarbon group, and a saturated hydrocarbon group is preferable. The number of carbon atoms in R¹ is preferably from 1 to 6, more preferably from 1 to 3, and still more preferably from 1 to 2.

As the hydrolyzable group, those described above are preferable.

Among them, L is preferably an alkoxy group having 1 to 4 carbon atoms or a halogen atom from the viewpoint of ease of production of the compound. L is preferably an alkoxy group having 1 to 4 carbon atoms, and more preferably an ethoxy group or a methoxy group from the viewpoint of less outgassing at the time of coating and more excellent storage stability of the compound.

n is an integer from 0 to 2, preferably 0 or 1, and more preferably 0. The presence of a plurality of L causes stronger adhesion of the surface treatment layer to a substrate.

When n is 1 or less, a plurality of L present in one molecule may be the same or different from each other. The plurality of L is preferably the same from the viewpoint of easy availability of the raw material and easy production of the compound. When n is 2, a plurality of R¹s present in one molecule may be the same or different from each other. The plurality of R¹s is preferably the same from the viewpoint of easy availability of the raw material and easy production of the compound.

### (Organopolysiloxane Residue)

The compound of the present disclosure includes an organopolysiloxane residue. The valence of the organopolysiloxane residue is not particularly limited, and is preferably linked to an alkyl group and a reactive silyl group. That is, the organopolysiloxane residue is preferably divalent or more, more preferably divalent to octavalent, and still more preferably divalent.

In the compound of the disclosure, preferably an alkyl group having two or more carbon atoms, an organopolysiloxane residue, and a reactive silyl group are linked in this order.

Examples of the organopolysiloxane residue include a chain organopolysiloxane residue, a cyclic organopolysiloxane residue, and a cage organopolysiloxane residue. Among them, the organopolysiloxane residue is preferably a chain organopolysiloxane residue, and more preferably a divalent chain organopolysiloxane residue.

Examples of the organopolysiloxane residue include the following Formulas B1 to B3.

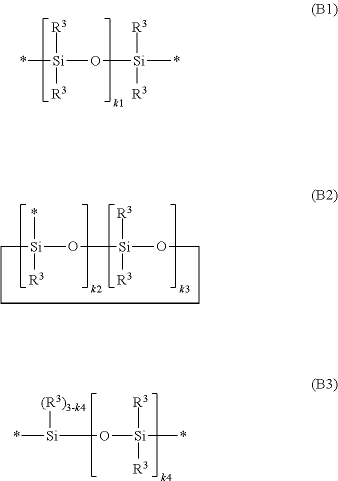

In Formulas B1 to B3, R³ each independently represents a hydrocarbon group.

In Formula B1, k1 represents an integer of one or more.

In Formula each of B2, k2 and k3 independently represents an integer of one or more.

In Formula B3, each k4 independently represents an integer from 1 to 3.

Examples of the hydrocarbon group represented by R³ include an aliphatic hydrocarbon group and an aromatic hydrocarbon group. Among them, the hydrocarbon group is preferably an aliphatic hydrocarbon group, and more preferably an alkyl group. The alkyl group may be any of a linear alkyl group, a branched alkyl group, and a cyclic alkyl group, and is preferably a linear alkyl group, more preferably a methyl group, an ethyl group, a n-propyl group, or a n-butyl group, and still more preferably a methyl group. The aromatic hydrocarbon group is preferably a phenyl group.

k1 is an integer from one or more, preferably from 2 to 600, more preferably from 3 to 500, still more preferably from 9 to 50, particularly preferably from 11 to 30, and most preferably from 11 to 25.

k2 is an integer from one or more, preferably from 2 to 600, and more preferably from 3 to 500.

k3 is an integer from one or more, preferably from 2 to 600, and more preferably from 3 to 500.

k4 is an integer from 1 to 3, and is preferably 1 or 2.

Among them, the organopolysiloxane residue is preferably a group represented by Formula B1 from the viewpoint of improving the water repellency and abrasion resistance of the surface treatment layer.

The compound of the disclosure is preferably represented by the following Formula 1 from the viewpoint of being more excellent in water repellency and abrasion resistance of the surface treatment layer.

(T-Z)ₚA(Si(R¹)ₙL₃₋ₙ)_{q} (1)

In Formula 1, T represents an alkyl group having two or more carbon atoms, Z represents a divalent organopolysiloxane residue, A represents a single bond or a (p+q)-valent linking group, each R¹ independently represents a monovalent hydrocarbon group, L represents a hydrolyzable group or a hydroxyl group, n is an integer from 0 to 2, and each of p and q independently represents an integer of one or more.

T in Formula 1 is an alkyl group having two or more carbon atoms, and the details of the alkyl group are as described above.

R¹, L, and n in Formula 1 are the same as R¹, L, and n in Formula A, and thus explanation thereof is omitted.

Z in Formula 1 is a divalent organopolysiloxane residue, and is preferably a group represented by Formula B1.

In Formula 1, A is a single bond or a (p+q)-valent linking group.

However, a terminal of A on a side which is bonded to Z is not an oxysilyl group. Examples of the oxysilyl group include —O—Si(CH₃)₂—.

A may be any group that does not impair the effects of the disclosure, and examples thereof include an alkylene group optionally having an etheric oxygen atom, a carbon atom, a nitrogen atom, a silicon atom, and a group obtained by removing Si(R¹)ₙL₃₋ₙ from Formulas (3-1A), (3-1B), and (3-1A-1) to (3-1A-7) described later.

A may be a Group (g2-1) to a Group (g2-14) described later.

p is an integer from one or more. p is preferably from 1 to 6, more preferably from 1 to 4, and still more preferably 1 from the viewpoint of more excellent water repellency of the surface treatment layer.

When p is two or more, a plurality of [T-Z] may be the same or different from each other.

q is an integer from one or more. q is preferably from 1 to 15, more preferably from 1 to 6, still more preferably from 2 to 4, and particularly preferably 2 or 3 from the viewpoint of more excellent abrasion resistance of the surface treatment layer.

When q is two or more, a plurality of [Si(R¹)ₙL₃₋ₙ] may be the same or different from each other.

The group represented by A(Si(R¹)ₙL₃₋ₙ)_{q} in Formula 1 is preferably a Group (3-1A) or a Group (3-1i), and more preferably a Group (3-1A).

-Q^{a}-X³¹(-Q^{b}-Si(R¹)ₙL₃₋ₙ)ₕ(—R³¹)ᵢ (3-1A)

-Q^{c}-[CH₂C(R³²)(-Q^{d}-Si(R¹)ₙL₃₋ₙ)]_{y}—R³³ (3-1B)

In the formulas (3-1A) and (3-1i), the definitions of R¹, L, and n are as described above.

In Formula (3-1A), Q^{a} represents a single bond or a divalent linking group.

However, a terminal of Q^{a} on a side which is bonded to Z is not an oxysilyl group.

Examples of the divalent linking group include a divalent hydrocarbon group, a divalent heterocyclic group, —O—, —S—, —SO₂—, —N(R^{d})—, —C(O)—, —Si(R^{a})₂—, and a group obtained by combining the two or more kinds of groups of them.

The divalent hydrocarbon group may be a divalent saturated hydrocarbon group, a divalent aromatic hydrocarbon group, an alkenylene group, or an alkynylene group. The divalent saturated hydrocarbon group may be linear, branched, or cyclic, and examples thereof include an alkylene group. The number of carbon atoms in the alkylene group is preferably from 1 to 30, more preferably from 1 to 20, still more preferably from 4 to 20, and particularly preferably from 5 to 15. The divalent aromatic hydrocarbon group is preferably one having 5 to 20 carbon atoms, and examples thereof include a phenylene group. An alkenylene group having 2 to 20 carbon atoms and an alkynylene group having 2 to 20 carbon atoms may be used.

The R^{a} is an alkyl group (preferably having 1 to 10 carbon atoms) or a phenyl group. The R^{d} is a hydrogen atom or an alkyl group (preferably having 1 to 10 carbon atoms).

Examples of the group in combination of the two or more kinds of groups of them include:
an alkylene group having —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—; an alkylene group having —N(R^{d})C(O)—, an alkylene group having —OC(O)N(R^{d})—, and an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—,
an alkylene group having —SO₂N(R^{d})—, and
an alkylene group —Si(R^{a})₂-phenylene group —Si(R^{a})₂.

Among them, Q^{a} is preferably a divalent hydrocarbon group, a divalent heterocyclic group, an alkylene group having —O—, —S—, —SO₂—, —N(R^{d})—, —C(O)—, —Si(R^{a})₂—, —OC(O)—, —C(O)O—, —C(O)S—, —C(O)(R^{d})—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—, and more preferably an alkylene group having —C(O)N(R^{d})—, —OC(O)—, or —NHC(O)—.

In Formula (3-1A), X³¹ is a single bond, an alkylene group, a carbon atom, a nitrogen atom, a silicon atom, a divalent to octavalent organopolysiloxane residue, or a group having a (h+i+1) valent ring.

However, when Q^{a} is a single bond, a terminal of X³¹ on a side which is bonded to Z is not an oxysilyl group. In cases other than the above, the terminal of X³¹ may be an oxysilyl group.

The alkylene group represented by X³¹ may have —O—, a silphenylene skeleton group, a divalent organopolysiloxane residue, or a dialkylsilylene group. The alkylene group may have a plurality of groups selected from the group consisting of a —O—, silphenylene skeleton group, a divalent organopolysiloxane residue, and a dialkylsilylene group.

The number of carbon atoms of the alkylene group represented by X³¹ is preferably from 1 to 20, and more preferably from 1 to 10.

Examples of the divalent to octavalent organopolysiloxane residue include a divalent organopolysiloxane residue and a (w2+1)-valent organopolysiloxane residue described later.

In Formula (3-1A), when X³¹ is a group having a (h+i+1)-valent ring, Q^{a} (-Q^{b}-Si(R¹)ₙL₃₋ₙ), and R³¹ are directly bonded to atoms constituting the ring. However, the ring is a ring other than the organopolysiloxane ring.

The ring in X³¹ may be any of a monocyclic ring, a fused polycyclic ring, a bridged ring, a spiro ring, and an assembled polycyclic ring, and the atom constituting the ring may be a carbocyclic ring composed of only carbon atoms, or may be a heterocyclic ring composed of a hetero atom having a divalent or above and a carbon atom. The bond between atoms constituting the ring may be a single bond or a multiple bond. The ring may be an aromatic ring or a non-aromatic ring.

The monocyclic ring is preferably a 4-membered ring to an 8-membered ring, and more preferably a 5-membered ring or a 6-membered ring. The fused polycyclic ring is preferably a fused polycyclic ring in which two or more rings of 4-membered to 8-membered rings are fused, and more preferably a fused polycyclic ring in which 2 or 3 rings selected from a 5-membered ring and a 6-membered ring are bonded, and a fused polycyclic ring in which one or two rings selected from a 5-membered ring and a 6-membered ring and one 4-membered ring are bonded. The bridged ring is preferably a bridged ring having a 5-membered ring or a 6-membered ring as the largest ring, and the spiro ring is preferably a spiro ring as a component of two of 4-membered to 6-membered rings. The assembled polycyclic ring is preferably an assembled polycyclic ring in which 2 or 3 rings selected from a 5-membered ring and a 6-membered ring are bonded via a single bond, from 1 to 3 carbon atoms, or one heteroatom having a valence of 2 or 3. In the assembled polycyclic ring, any one of Q^{a}, (-Q^{b}-Si(R¹)ₙL₃₋ₙ) and R³¹ (when i=one or more) is preferably bonded to each ring.

As the hetero atom constituting the ring, a nitrogen atom, an oxygen atom, and a sulfur atom are preferable, and a nitrogen atom and an oxygen atom are more preferable. The number of the heteroatoms constituting the ring is preferably 3 or less. When the number of the heteroatoms constituting the ring is two or more, those heteroatoms may be different.

The ring for X³¹ is preferably one kind selected from the group consisting of a 3-membered to 8-membered aliphatic rings, a benzene ring, 3-membered to 8-membered heterocyclic rings, a fused ring in which 2 or 3 rings of these rings are fused, a bridged ring having a 5-membered ring or a 6-membered ring as the largest ring, and an assembled polycyclic ring which has the two or more rings of these rings and in which the linking group is a single bond, an alkylene group having 3 or less carbon atoms, an oxygen atom or a sulfur atom, from the viewpoint of easily producing a compound and being further excellent in the abrasion resistance of the surface treatment layer.

Preferred rings are benzene rings, 5- or 6-membered aliphatic rings, 5- or 6-membered heterocycles having a nitrogen atom or an oxygen atom, and fused rings of 5- or 6-membered carbocycles and 4-membered to 6-membered heterocycles.

Specific examples of the ring include the following rings, 1,3-cyclohexadiene ring, 1,4-cyclohexadiene ring, anthracene ring, cyclopropane ring, decahydronaphthalene ring, norbornene ring, norbornadiene ring, furan ring, pyrrole ring, thiophene ring, pyrazine ring, morpholine ring, aziridine ring, isoquinoline ring, oxazole ring, isoxazole ring, thiazole ring, imidazole ring, pyrazole ring, pyran ring, pyridazine ring, pyrimidine ring, and indene ring. A ring having an oxo group (═O) is also described below.

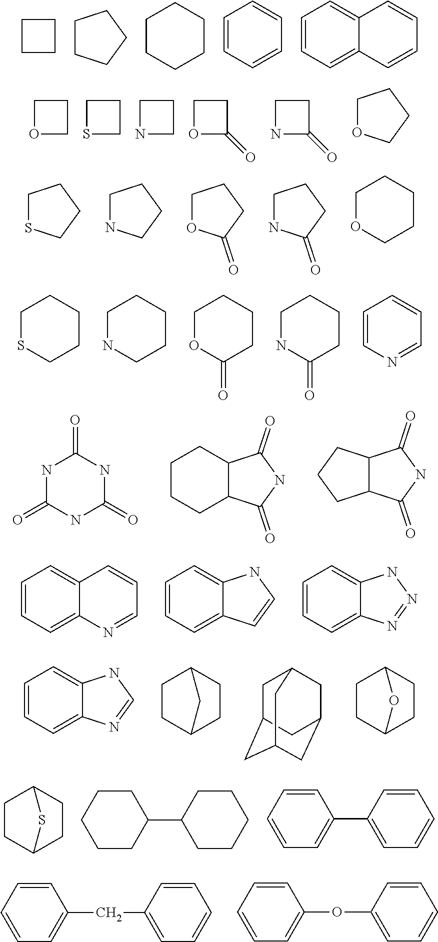

A bond that does not constitute a ring of atoms constituting the ring in X³¹ is a bond bonded to Q^{a}, (-Q^{b}-Si(R)ₙL₃₋ₙ), or R³¹. When there are remaining bonds, the remaining bonds are bonded to a hydrogen atom or a substituent. Examples of the substituent include a halogen atom, an alkyl group (an etheric oxygen atom may be contained between the carbon-carbon atoms), a cycloalkyl group, an alkenyl group, an allyl group, an alkoxy group, and an oxo group (═O).

When one of the carbon atoms constituting the ring has two bonds bonded to Q^{a} (-Q^{b}-Si(R¹)ₙL₃₋ₙ) or R³¹, Q^{a} and (-Q^{b}-Si(R¹)ₙL₃₋ₙ) may be bonded to one of the carbon atoms, or two (-Q^{b}-Si(R¹)ₙL₃₋ₙ) may be bonded to one of the carbon atoms. Q^{a}, and (-Q^{b}-Si(R¹)ₙL₃₋ₙ) or R³¹ are preferably bonded to another ring-constituting atom. Each of h pieces of (-Q^{b}-Si(R¹)ₙL₃₋ₙ) may be bonded to a separate ring-constituting atom, and two of h pieces of (-Q^{b}-Si(R¹)ₙL₃₋ₙ) may be bonded to one ring-constituting carbon atom, and there may be two or more ring-constituting carbon atoms to which two pieces of (-Q^{b}-Si(R¹)ₙL₃₋ₙ) are bonded. Each of i pieces of R³¹ may be bonded to a separate ring-constituting atom, two pieces of R³¹ may be bonded to one ring-constituting carbon atom, and further, there may be two or more ring-constituting carbon atoms to which two pieces of R³¹ are bonded.

Among them, from the viewpoint of improving the abrasion resistance of the surface treatment layer, X³¹ is preferably a carbon atom, a nitrogen atom, a silicon atom, quadrivalent to octavalent organopolysiloxane residue, or a group having a (h+i+1)-valent ring, and more preferably a carbon atom.

In Formula (3-1A), Q^{b} represents a single bond or a divalent linking group.

The definition of the divalent linking group is the same as the definition described in Q^{a} described above.

However, when Q^{a} and X³¹ are a single bond, a terminal of Q^{b} on a side which is bonded to Z is not an oxysilyl group. In other cases, the terminal of Q^{b} may be an oxysilyl group.

When h is 1 and Q^{b} is an alkylene group, the Q^{b}-side terminal of Q^{a}-X³1 is not an alkylene group.

Among them, Q^{b} is preferably an alkylene group which may have an etheric oxygen atom. The number of carbon atoms in the alkylene group is preferably from 1 to 30, more preferably from 1 to 20, still more preferably from 2 to 20, and may be from 2 to 10, from 2 to 6, or from 2 to 5. Examples thereof include 2, 3, 8, 9, and 11. The number of carbon atoms may be from 1 to 10.

In Formula (3-1A), R³¹ is a hydrogen atom, a hydroxyl group, or an alkyl group.

The number of carbon atoms in the alkyl group is preferably from 1 to 5, more preferably from 1 to 3, and still more preferably 1.

When X³¹ is a single bond or an alkylene group, h is 1, and i is 0;
when X³¹ is a nitrogen atom, h is an integer from 1 to 2, i is an integer from 0 to 1, and h+i=2 is satisfied;
when X³¹ is a carbon atom or a silicon atom, h is an integer from 1 to 3, i is an integer from 0 to 2, and h+i=3 is satisfied; and
when X³¹ is a divalent to octavalent organopolysiloxane residue, h is an integer from 1 to 7, i is an integer from 0 to 6, and h+i=1 to 7 is satisfied.

When X³¹ is a group having a (h+i+1)-valent ring, h is an integer from 1 to 7, i is an integer from 0 to 6, and h+i=1 to 7 is satisfied.

When there are two or more pieces of (-Q^{b}-Si(R¹)ₙL₃₋ₙ), two or more pieces of (-Q^{b}-Si(R¹)ₙL₃₋ₙ) may be the same or different from each other. When there are two or more pieces of R³¹, two or more pieces of (—R³¹) may be the same or different from each other.

Among them, i is preferably 0 from the viewpoint of improving the abrasion resistance of the surface treatment layer.

In Formula (3-1A), when Q^{a}, X³¹, and Q^{b} are single bonds, [Si(R¹)ₙL₃₋ₙ] is directly bonded to Z.

In Formula (3-1i), Q^{c} represents a single bond or a divalent linking group.

However, a terminal of Q^{c} on a side which is bonded to Z is not an oxysilyl group.

The definition of the divalent linking group is the same as the definition described in Q^{a} described above.

In Formula (3-1i), R³² is a hydrogen atom or an alkyl group having 1 to 10 carbon atoms, and is preferably a hydrogen atom from the viewpoint of easily producing a compound.

The alkyl group is preferably a methyl group.

In Formula (3-1i), Q^{d} is a single bond or an alkylene group. The number of carbon atoms in the alkylene group is preferably from 1 to 10, and more preferably from 1 to 6. Q^{d} is preferably a single bond or CH₂— from the viewpoint of easily producing a compound.

In Formula (3-1i), R³³ is a hydrogen atom or a halogen atom, and is preferably a hydrogen atom from the viewpoint of easily producing a compound.

y is an integer from 1 to 10 and preferably an integer from 1 to 6.

Two or more pieces of [CH₂C(R³²)(-Q^{d}-Si(R¹)ₙL₃₋ₙ)] may be the same or different from each other.

As the Group (3-1A), Groups (3-1A-1) to (3-1A-7) are preferable.

—(X³²)ₛ₁-Q^{b1}-Si(R¹)ₙL₃₋ₙ (3-1A-1)

—(X³³)ₛ₂-Q^{a2}-N[-Q^{b2}-Si(R¹)ₙL₃₋ₙ]₂ (3-1A-2)

-Q^{a3}-Si(R^{g})[-Q^{b3}-Si(R¹)ₙL₃₋ₙ]₂ (3-1A-3)

-[Q^{e}]ₛ₄-Q^{a4}-(O)ₜ₄—C[—(O)ᵤ₄-Q^{b4}-Si(R¹)ₙL₃₋ₙ]_{3-w1}(—R³¹)_{w1} (3-1A-4)

-Q^{a5}-Si[-Q^{b5}-Si(R¹)ₙL₃₋ₙ]₃ (3-1A-5)

-[Q^{e}]ᵥ-Q^{a6}-Z^{a}[-Q^{b6}-Si(R¹)ₙL₃₋ₙ]_{w2} (3-1A-6)

-[Q^{e}]ₛ₄-Q^{a4}-(O)ₜ₄—Z^{c}[—(O-Q^{b4})ᵤ₄-Si(R¹)ₙL₃₋ₙ]_{w3}(—OH)_{w4} (3-1A-7)

In Formulas (3-1A-1) to (3-1A-7), the definitions of R¹, L, and n are as described above.

However, a terminal of the Group (3-1A-1) to (3-1A-7) on a side which is bonded to Z is not an oxysilyl group.

Among them, the Group (3-1A) is preferably a Group (3-1A-4) or a Group (3-1A-5).

In the Group (3-1A-1), X³² is —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})— (however, N in the formulas binds to Q^{b1})

The definition of R^{d} is as described above.

s1 is 0 or 1.

Among them, X³² is preferably —O—, —S—, —N(R^{d})—, —C(O)O—, —C(O)S—, —N(R^{d})C(O)N(R^{d})—, —OC(O)N(R^{d})—, or —C(O)N(R^{d})—, and more preferably —C(O)O— or —C(O)N(R^{d})—.

Q^{b1} is a single bond or an alkylene group. The alkylene group may have a —O—, silphenylene skeleton group, or a dialkylsilylene group. The alkylene group may have a plurality of groups selected from the group consisting of a —O—, silphenylene skeleton group, a divalent organopolysiloxane residue, and a dialkylsilylene group.

When the alkylene group has a —O—, silphenylene skeleton group, a divalent organopolysiloxane residue, or a dialkylsilylene group, it is preferable to have these groups between carbon-carbon atoms.

The number of carbon atoms of the alkylene group represented by Q^{b1} is preferably from 1 to 30, more preferably from 1 to 20, still more preferably from 2 to 20, and particularly preferably from 2 to 6. The number of carbon atoms may be from 1 to 10.

Among them, s1 is preferably 0, and Q^{b1} is preferably an alkylene group having 2 to 6 carbon atoms.

Specific examples of the Group (3-1A-1) include the following groups. In the following formula, * represents a bonding position with Z.

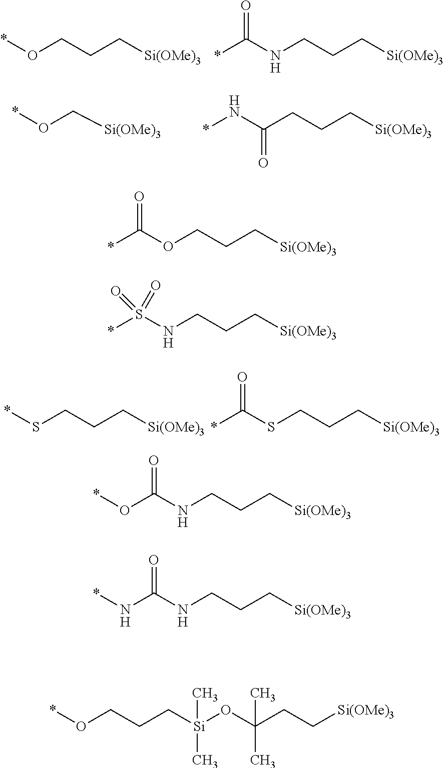

In the Group (3-1A-2), X³³ is —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—.

The definition of R^{d} is as described above.

s2 is 0 or 1. s2 is preferably 0 from the viewpoint of easily producing a compound.

Among them, X³³ is preferably —O—, —C(O)O—, or —C(O)N(R^{d})—.

Q^{a2} is a group having a single bond, an alkylene group, —C(O)—, or a group having an etheric oxygen atom, —C(O)—, —C(O)O—, —OC(O)—, —C(O)N(R^{d})—, —N(R^{d})C(O)—, —N(R^{d})C(O)N(R^{d})—, —N(R^{d}) C(O)O—, —OC(O)N(R^{d})—, —SO₂N(R^{d})—, —N(R^{d})SO₂—, —C(O)N(R^{d})—, or NH— between carbon-carbon atoms of an alkylene group having two or more carbon atoms.

The number of carbon atoms of the alkylene group represented by Q^{a2} is preferably from 1 to 20, more preferably from 1 to 10, still more preferably from 1 to 6, and particularly preferably from 1 to 3.

The number of carbon atoms of a group having an etheric oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH— between carbon-carbon atoms of the alkylene group having two or more carbon atoms represented by Q^{a2} is preferably from 2 to 10, more preferably from 2 to 6.

Q^{a2} is preferably a single bond from the viewpoint of easily producing a compound.

Q^{b2} is an alkylene group or a group having a divalent organopolysiloxane residue, an etheric oxygen atom, or NH— between carbon-carbon atoms of an alkylene group having two or more carbon atoms.

The number of carbon atoms in the alkylene group represented by Q^{b2} is preferably from 1 to 30, more preferably from 1 to 20, still more preferably from 2 to 20, and may be from 2 to 10, from 2 to 6. Examples thereof include 2, 3, 8, 9, and 11. The number of carbon atoms may be from 1 to 10.

The number of carbon atoms of a divalent organopolysiloxane residue, an etheric oxygen atom, or a group having —NH— between carbon-carbon atoms of the alkylene group having two or more carbon atoms represented by Q^{b2} is preferably from 2 to 10, and more preferably from 2 to 6.

Q^{b2} is preferably —CH₂CH₂CH₂— or —CH₂CH₂OCH₂CH₂CH₂— from the viewpoint of easily producing a compound (however, the right side is bonded to Si).

Two pieces of [-Q^{b2}-Si(R¹)ₙL₃₋ₙ] may be the same or different from each other.

Specific examples of the Group (3-1A-2) include the following groups. In the following formula, * represents a bonding position with Z. In the formula, α in (CH₂)_{α} bonded to the reactive silyl group is an integer representing the number of methylene groups, and is preferably from 1 to 30, more preferably from 1 to 20, still more preferably from 2 to 20, may be from 2 to 10, or may be from 2 to 6. Examples thereof include 2, 3, 8, 9, and 11. The number of carbon atoms may be from 1 to 10. A plurality of a contained in the same compound may be the same or different from each other, but is preferably the same. For example, the plurality of a contained in the same compound is all 2, 3, 8, 9, and 11. The same applies hereinafter.

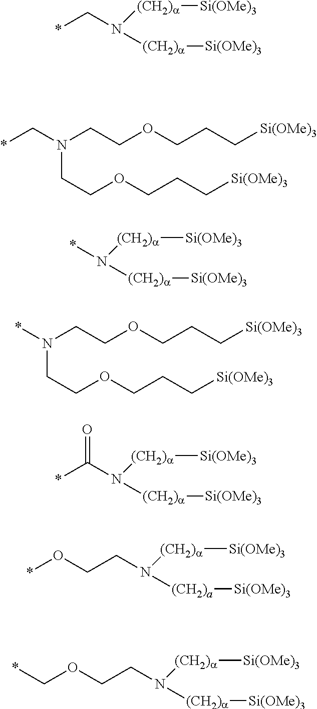

In the Group (3-1A-3), Q^{a3} is a single bond or an alkylene group optionally having an etheric oxygen atom. Q^{a3} is preferably a single bond from the viewpoint of easily producing a compound.

The number of carbon atoms of the alkylene group optionally having an etheric oxygen atom is preferably from 1 to 10, and particularly preferably from 2 to 6.

R⁹ is a hydrogen atom, a hydroxyl group, or an alkyl group.

R⁹ is preferably a hydrogen atom or an alkyl group from the viewpoint of easily producing a compound. The number of carbon atoms in the alkyl group is preferably from 1 to 10, more preferably from 1 to 4, and still more preferably a methyl group.

Q^{b3} is an alkylene group or a group having an etheric oxygen atom or a divalent organopolysiloxane residue between carbon-carbon atoms of the alkylene group having two or more carbon atoms.

The number of carbon atoms in the alkylene group represented by Q^{b3} is preferably from 1 to 30, more preferably from 1 to 20, still more preferably from 2 to 20, and may be from 2 to 10, from 2 to 6. Examples thereof include 2, 3, 8, 9, and 11. The number of carbon atoms may be from 1 to 10.

The number of carbon atoms of the group having an etheric oxygen atom or a divalent organopolysiloxane residue between carbon-carbon atoms of the alkylene group having two or more carbon atoms represented by Q^{b3} is preferably from 2 to 20, more preferably from 2 to 10, and still more preferably from 2 to 6.

Q^{b3} is preferably —CH₂CH₂—, —CH₂CH₂CH₂—, or —CH₂CH₂CH₂CH₂CH₂CH₂CH₂CH₂— from the viewpoint of easily producing a compound.

Two pieces of [-Q^{b3}-Si(R¹)ₙL₃₋ₙ] may be the same or different from each other.

Specific examples of the Group (3-1A-3) include the following groups. In the following formula, * represents a bonding position with Z.

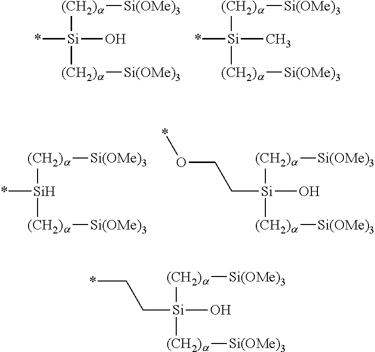

In the Group (3-1A-4), Q^{e} is —C(O)O—, —SO₂N(R^{d})—, —N(R^{d})SO₂—, —N(R^{d})C(O)—, or —C(O)N(R^{d})—, or an alkylene group having —C(O)O—, an alkylene group having —SO₂N(R^{d})—, an alkylene group having —N(R^{d})SO₂—, or an alkylene group having —N(R^{d})C(O).

In the alkylene group having —C(O)O—, the alkylene group having —SO₂N(R^{d})—, the alkylene group having —N(R^{d})SO₂—, or the alkylene group having —N(R^{d})C(O), the alkylene group is preferably located on the side bonded to Z.

The definition of R³¹ is as described above. When w1 is 1 or 2, R³¹ is preferably a hydrogen atom.

s4 is 0 or 1.

Q^{a4} is a single bond or an alkylene group optionally having an etheric oxygen atom.

The number of carbon atoms of the alkylene group optionally having an etheric oxygen atom is preferably from 1 to 20, more preferably from 1 to 10, still more preferably from 1 to 6, and particularly preferably from 1 to 3.

t4 is 0 or 1(however, when Q^{a4} is a single bond, Q^{a4} is 0).

As -Q^{a4}-(O)ₜ₄—, when s4 is 0, a single bond, —CH₂O—, —CH₂OCH₂—, —CH₂OCH₂CH₂O—, —CH₂OCH₂CH₂OCH₂—, or —CH₂OCH₂CH₂CH₂CH₂OCH₂— is preferable (however, the left side is bonded to Z), and when s4 is 1, a single bond, —CH₂—, or —CH₂CH₂— is preferable from the viewpoint of easily producing a compound.

Q^{b4} is an alkylene group, and the alkylene group may have —O—, —C(O)N(R^{d})— (the definition of R^{d} is as described above), a silphenylene skeleton group, a divalent organopolysiloxane residue, or a dialkylsilylene group.

When the alkylene group has a —O— or silphenylene skeleton group, the alkylene group preferably has a —O— or silphenylene skeleton group between carbon-carbon atoms. When the alkylene group has —C(O)N(R^{d})—, a dialkylsilylene group, or a divalent organopolysiloxane residue, it is preferable to have these groups between carbon-carbon atoms or at the terminal on the side which is bonded to (0)ᵤ₄.

The number of carbon atoms in the alkylene group represented by Q^{b4} is preferably from 1 to 30, more preferably from 1 to 20, still more preferably from 2 to 20, and may be from 2 to 10, from 2 to 6. Examples thereof include 2, 3, 8, 9, and 11. The number of carbon atoms may be from 1 to 10.

u4 is 0 or 1.

As —(O)ᵤ₄₋Q^{b4}-, —CH₂CH₂—, —CH₂CH₂CH₂—, —CH₂OCH₂CH₂CH₂—, —CH₂OCH₂CH₂CH₂CH₂CH₂—, —OCH₂CH₂CH₂—, —OSi(CH₃)₂CH₂CH₂CH₂—, —OSi(CH₃)₂OSi(CH₃)₂CH₂CH₂CH₂—, —CH₂CH₂CH₂Si(CH₃)₂PhSi(CH₃)₂CH₂CH₂— are preferable from the viewpoint of easily producin g a compound (however, the right side is bonded to Si).

w1 is an integer from 0 to 2, preferably 0 or 1, and particularly preferably 0. When there are two or more pieces of [—(O)ᵤ₄-Q^{b4}-Si(R¹)ₙL₃₋ₙ], two or more pieces of [—(O)ᵤ₄-Q^{b4}-Si(R¹)ₙL₃₋ₙ] may be the same or different from each other.

When there are two or more pieces of R³¹, two or more pieces of (—R³¹) may be the same or different from each other.

Specific examples of the Group (3-1A-4) include the following groups. In the following formula, * represents a bonding position with Z.

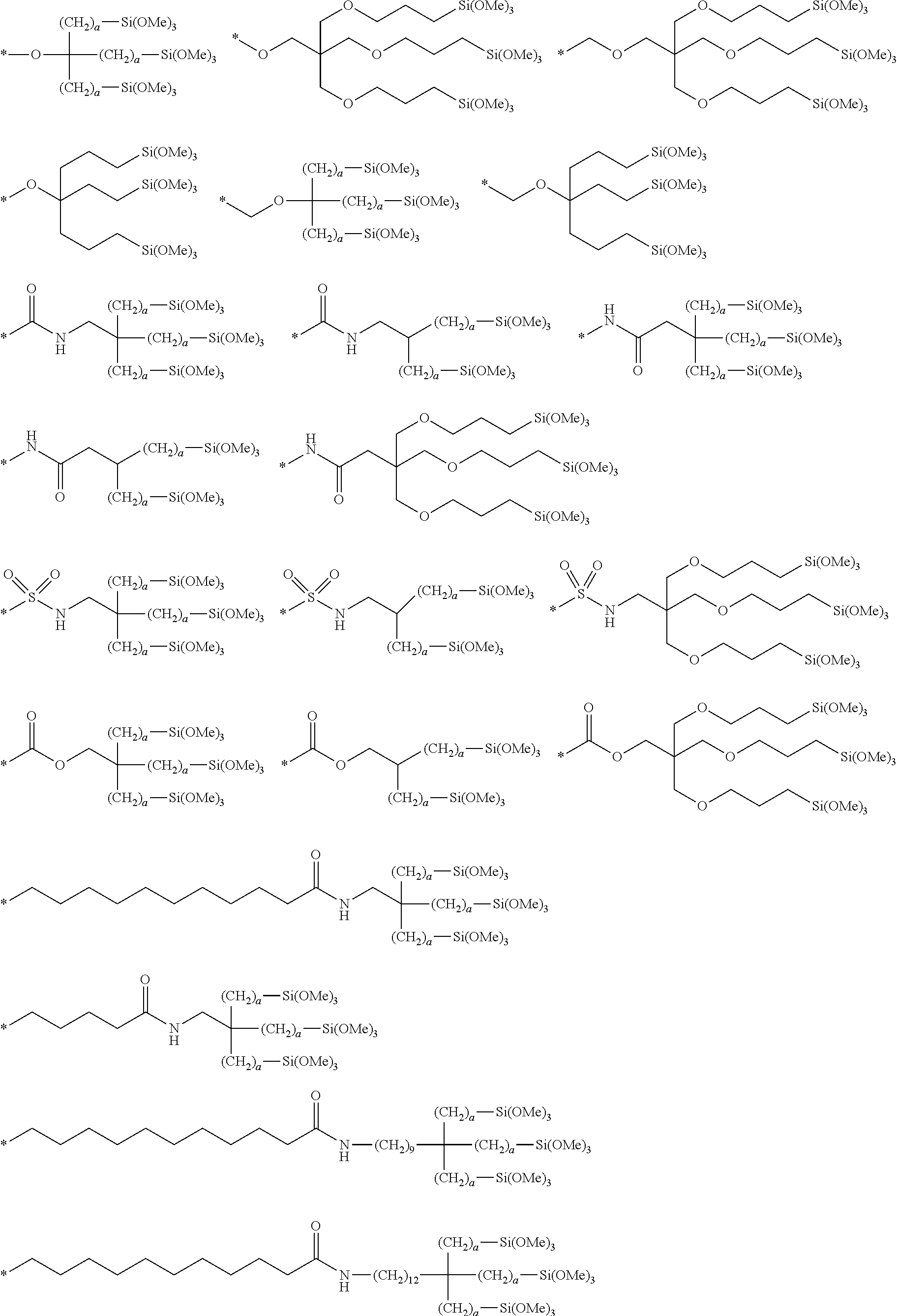

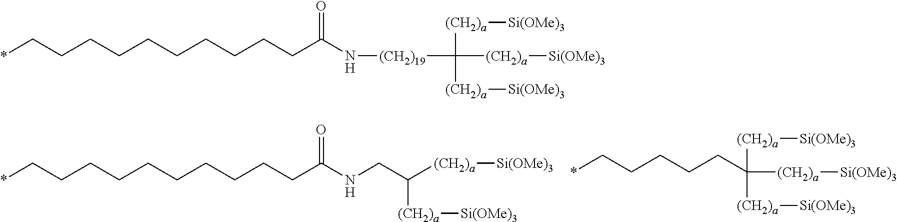

In the Group (3-1A-5), Q^{a5} is an alkylene group optionally having an etheric oxygen atom.

The number of carbon atoms of the alkylene group optionally having an etheric oxygen atom is preferably from 1 to 10, and particularly preferably from 2 to 6.

Q^{a5} is preferably —OCH₂CH₂CH₂—, —OCH₂CH₂OCH₂CH₂CH₂—, —CH₂CH₂—, or —CH₂CH 2CH₂— from the viewpoint of easily producing a compound (however, the right side is bonded t o Si).

Q^{b5} is an alkylene group or a group having an etheric oxygen atom or a divalent organopolysiloxane residue between carbon-carbon atoms of the alkylene group having two or more carbon atoms.

The number of carbon atoms in the alkylene group represented by Q^{b5} is preferably from 1 to 30, more preferably from 1 to 20, still more preferably from 2 to 20, and may be from 2 to 10, from 2 to 6. Examples thereof include 2, 3, 8, 9, and 11. The number of carbon atoms may be from 1 to 10.

The number of carbon atoms of the group having an etheric oxygen atom or a divalent organopolysiloxane residue between carbon-carbon atoms of the alkylene group having two or more carbon atoms represented by Q^{b5} is preferably from 2 to 20, more preferably from 2 to 10, and still more preferably from 2 to 6.

Q^{b5} is preferably —CH₂CH₂CH₂— or —CH₂CH₂OCH₂CH₂CH₂— from the viewpoint of easily producing a compound (however, the right side is bonded to Si(R¹)ₙL₃₋ₙ).

Three pieces of [-Q^{b5}-Si(R¹)ₙL₃₋ₙ] may be the same or different from each other.

Specific examples of the Group (3-1A-5) include the following groups. In the following formula, * represents a bonding position with Z.

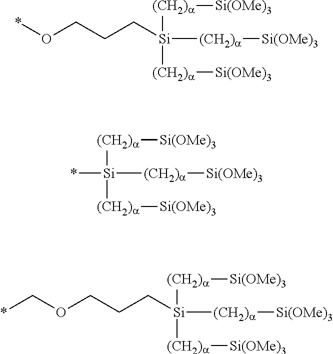

The definition of Q^{c} in Group (3-1A-6) is as defined in the group (3-1A-4).

v is 0 or 1.

Q^{a6} is an alkylene group optionally having an etheric oxygen atom.

The number of carbon atoms of the alkylene group optionally having an etheric oxygen atom is preferably from 1 to 10, and particularly preferably from 2 to 6.

Q^{a6} is preferably —CH₂OCH₂CH₂CH₂—, —CH₂OCH₂CH₂OCH₂CH₂CH₂—, —CH₂CH₂—, or —CH₂CH₂CH₂— from the viewpoint of easily producing a compound (however, the right side is bonded to Z^{a}).

Z^{a} is a (w2+1)-valent organopolysiloxane residue or a (w2+1)-valent group having an alkylene group between the organopolysiloxane residue and the organopolysiloxane residue.

w2 is an integer from 2 to 7.

Examples of the (w2+1)-valent organopolysiloxane residue and the (w2+1)-valent group having an alkylene group between the organopolysiloxane residue and the organopolysiloxane residue include the following groups. However, R^{a} in the following formula is as described above. * indicates the binding site.

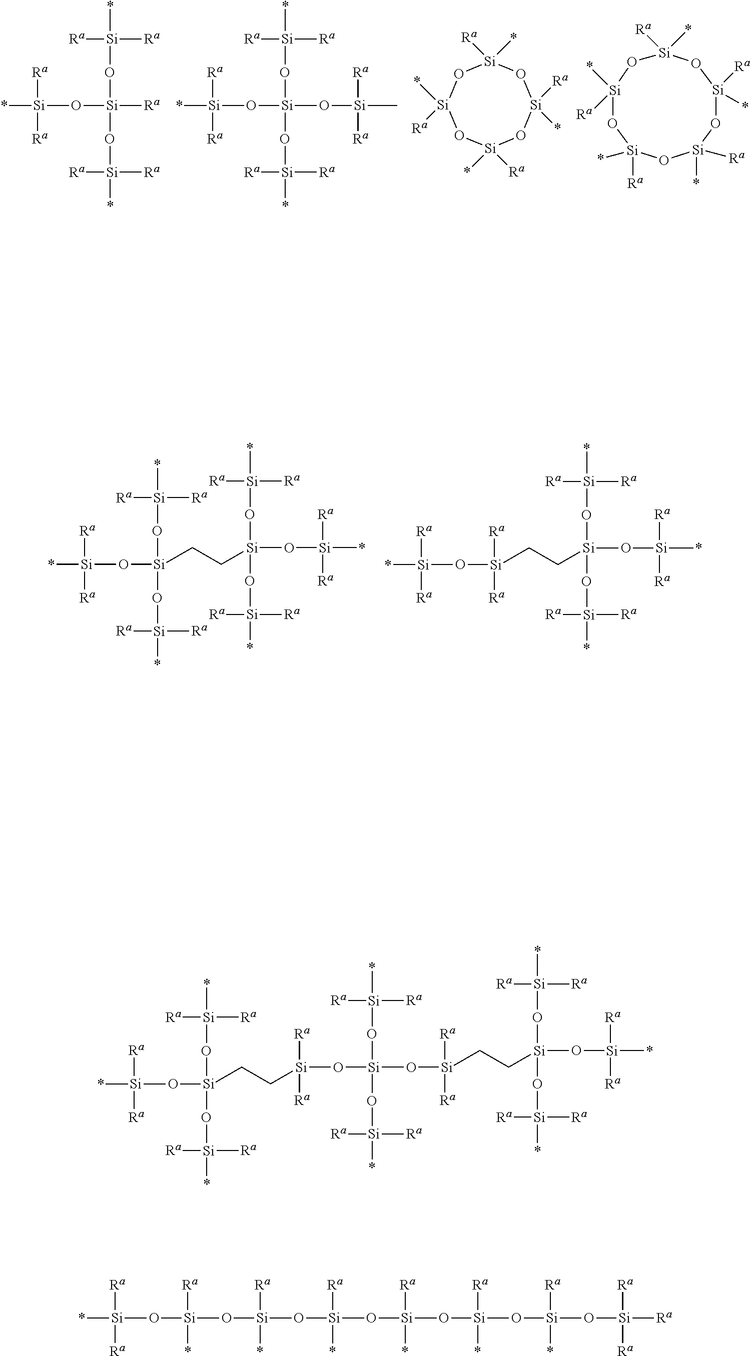

Q^{b6} is an alkylene group or a group having an etheric oxygen atom or a divalent organopolysiloxane residue between carbon-carbon atoms of the alkylene group having two or more carbon atoms.

The number of carbon atoms in the alkylene group represented by Q^{b6} is preferably from 1 to 30, more preferably from 1 to 20, still more preferably from 2 to 20, and may be from 2 to 10, from 2 to 6. Examples thereof include 2, 3, 8, 9, and 11. The number of carbon atoms may be from 1 to 10.

The number of carbon atoms of the group having an etheric oxygen atom or a divalent organopolysiloxane residue between carbon-carbon atoms of the alkylene group having two or more carbon atoms represented by Q^{b6} is preferably from 2 to 20, more preferably from 2 to 10, and still more preferably from 2 to 6.

Q^{b6} is preferably —CH₂CH₂— or —CH₂CH₂CH₂— from the viewpoint of easily producing a compound.

w2 pieces of [-Q^{b6}-Si(R¹)ₙL₃₋ₙ] may be the same or different from each other.

Specific examples of the Group (3-1A-6) include the following groups. In the following formula, * represents a bonding position with Z.

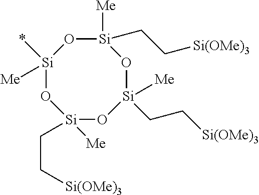

In the Group (3-1A-7), Z° is a (w3+w4+1)-valent hydrocarbon group.

w3 is an integer of 4 or more.

w4 is an integer of 0 or more.

The definitions and preferred ranges of Q^{c}, s4, Q^{a4}, t4, Q^{b4}, and u4 are the same as the definitions of the respective reference numerals in the Group (3-1A-4).

Z^{c} may be composed of a hydrocarbon chain, may have an etheric oxygen atom between carbon-carbon atoms of the hydrocarbon chain, and is preferably composed of a hydrocarbon chain.

The valence of Z^{c} is preferably from pentavalent to 20 valence, more preferably from pentavalent to decavalent, still more preferably from pentavalent to octavalent, and particularly preferably from pentavalent to hexavalent.

The number of carbon atoms in Z^{c} is preferably from 3 to 50, more preferably from 4 to 40, and still more preferably from 5 to 30.

w3 is preferably from 4 to 20, more preferably from 4 to 16, still more preferably from 4 to 8, and particularly preferably from 4 to 5.

w4 is preferably from 0 to 10, more preferably from 0 to 8, still more preferably from 0 to 6, particularly preferably from 0 to 3, and most preferably from 0 to 1.

When there are two or more pieces of [—(O-Q^{b4})ᵤ₄-Si(R¹)ₙL₃₋ₙ], two or more pieces of [—(O-Q^{b4})ᵤ₄-Si(R¹)ₙL₃₋ₙ] may be the same or different from each other.

Specific examples of the Group (3-1A-7) include the following groups. In the following formula, * represents a bonding position with Z.

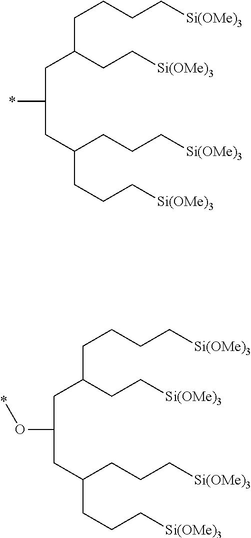

A in Formula 1 may be a Group (g2-1) (where, j1=d1+d3 and g1=d2+d4), a Group (g2-2) (where, j1=e1 and g1=e2), a Group (g2-3) (where, j1=1 and g1=2), a Group (g2-4) (where, j1=h1 and g1=h2), a Group (g2-5) (where, j1=i1 and g1=i2), a Group (g2-6) (where, j1=1 and g1=1), or a Group (g2-7) (where j1=1 and g1=i3).

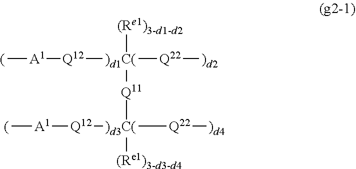

(-A¹-Q¹²)ₑ₁C(R^{e2})₄₋ₑ₁₋ₑ₂(-Q²²-)ₑ₂ (g2-2)

-A¹-Q¹³-N(-Q²³-)₂ (g2-3)

(-A¹-Q¹⁴-)ₕ₁Z¹(-Q²⁴-)ₕ₂ (g2-4)

(-A¹-Q¹⁵-)ᵢ₁Si(R^{e3})₄₋ᵢ₁₋ᵢ₂(-Q²⁵-)ᵢ₂ (g2-5)

-A¹-Q²⁶- (g2-6)

-A¹-Q¹²-CH(-Q²²-)—Si(R^{e3})₃₋ᵢ₃(-Q²⁵-)ᵢ₃ (g2-7)

However, in Formulas (g2-1) to (g2-7), the A¹ side is bonded to Z, and the Q²², Q²³, Q²⁴, Q²⁵, or Q²⁶ side is bonded to [—Si(R¹)ₙL₃₋ₙ].

A¹ is a single bond, —C(O)NR⁶—, —C(O)—, —OC(O)O—, —NHC(O)O—, —NHC(O)NR⁶—, —O—, or SO₂NR⁶—.

Q¹¹ is a single bond, —O—, an alkylene group, or a group having —C(O)NR⁶—, —C(O)—, —NR⁶—,or —O— between carbon-carbon atoms of an alkylene group having two or more carbon atoms.

Q¹² is a single bond, an alkylene group, or a group having —C(O)NR⁶—, —C(O)—, —NR⁶—, or —O— between carbon-carbon atoms of an alkylene group having two or more carbon atoms, and when A has two or more pieces of Q¹², two or more pieces of Q¹² may be the same or different from each other.

Q¹³ is a single bond (where, A¹ is —C(O)—), an alkylene group, a group having —C(O)NR⁶—, —C(O)—, —NR— or —O— between carbon-carbon atoms of an alkylene group having two or more carbon atoms, or a group having —C(O)— at an N-side terminal of an alkylene group.

Q¹⁴ is Q¹² when the atom in Z¹ to which Q¹⁴ is bonded is a carbon atom, Q¹³ when the atom in Z¹ to which Q¹⁴ is bonded is a nitrogen atom, and when A² has two or more pieces of Q¹⁴, two or more pieces of Q¹⁴ may be the same or different from each other.

Q¹⁵ is an alkylene group, or a group having —C(O)NR⁶—, —C(O)—, —NR⁶—, or —O— between carbon-carbon atoms of an alkylene group having two or more carbon atoms, and when A has two or more pieces of Q¹⁵, the two or more Q¹⁵ may be the same or different from each other.

Q²² is an alkylene group, a group having —C(O)NR⁶—, —C(O)—, —NR⁶—, or —O— between carbon-carbon atoms of an alkylene group having two or more carbon atoms, a group having —C(O)NR⁶—, —C(O)—, —NR⁶—, or —O— at a terminal of the alkylene group on a side which is not connected to Si, or a group having —C(O)NR⁶—, —C(O)—, —NR⁶—, or —O— between carbon-carbon atoms of an alkylene group having two or more carbon atoms and having —C(O)NR⁶—, —C(O)—, —NR⁶—, or —O— at a terminal on a side which is not connected to Si, and when A has two or more pieces of Q²², two or more pieces of Q²² may be the same or different from each other.

Q²³ is an alkylene group or a group having —C(O)NR⁶—, —C(O)—, —NR⁶— or —O— between carbon-carbon atoms of an alkylene group having two or more carbon atoms, and two pieces of Q²³ may be the same or different from each other.

Q²⁴ is Q²² when the atom in Z¹ to which Q²⁴ is bonded is a carbon atom, Q²³ when the atom in Z¹ to which Q²⁴ is bonded is a nitrogen atom, and when A has two or more pieces of Q²⁴, two or more pieces of Q²⁴ may be the same or different from each other.

Q²⁵ is an alkylene group, or a group having —C(O)NR⁶—, —C(O)—, —NR⁶—, or —O— between carbon-carbon atoms of an alkylene group having two or more carbon atoms, and when A has two or more pieces of Q²⁵, two or more pieces of Q²⁵ may be the same or different from each other.

Q²⁶ is an alkylene group, or a group having —C(O)NR⁶—, —C(O)—, —NR⁶—, or —O— between carbon-carbon atoms of an alkylene group having two or more carbon atoms.

Z¹ is a group having a (h1+h2)-valent ring structure having a carbon atom or a nitrogen atom to which Q¹⁴ is directly bonded and having a carbon atom or nitrogen atom to which Q²⁴ is directly bonded.

R^{e1} is a hydrogen atom or an alkyl group, and when A has two or more pieces of R^{e1}, the two or more pieces of R^{e1} may be the same or different from each other.

R^{e2} is a hydrogen atom, a hydroxyl group, an alkyl group, or an acyloxy group.

R^{e3} is an alkyl group. R⁶ is a hydrogen atom, an alkyl group having 1 to 6 carbon atoms, or a phenyl group.

d1 is an integer from 0 to 3, and is preferably 1 or 2.

d2 is an integer from 0 to 3, and is preferably 1 or 2.

d1+d2 is an integer from 1 to 3.

d3 is an integer from 0 to 3, and is preferably 0 or 1.

d4 is an integer from 0 to 3, and is preferably 2 or 3.

d3+d4 is an integer from 1 to 3.

d1+d3 is an integer from 1 to 5, and is preferably 1 or 2.

d2+d4 is an integer from 1 to 5, and is preferably 4 or 5.

e1+e2 is 3 or 4.

e1 is an integer from 1 to 3, and is preferably 1 or 2.

e2 is an integer from 1 to 3, and is preferably 2 or 3.

h1 is an integer of 1 or more, and is preferably 1 or 2.

h2 is an integer of 1 or more, and is preferably 2 or 3.

i1+i2 is 3 or 4.

i1 is an integer from 1 to 3, and is preferably 1 or 2.

i2 is an integer from 1 to 3, and is preferably 2 or 3.

i3 is 2 or 3.

The number of carbon atoms in the alkylene group of Q¹¹, Q¹², Q¹³, Q¹⁴, Q¹⁵, Q²², Q²³, Q²⁴, Q²⁵, and Q²⁶ is preferably from 1 to 30, more preferably from 1 to 20, still more preferably from 2 to 20, may be from 2 to 10, or may be from 2 to 6 from the viewpoint of easily producing a compound and being further excellent in abrasion resistance of the surface treatment layer. Examples thereof include 2, 3, 8, 9, and 11. The number of carbon atoms may be from 1 to 10, from 1 to 6, or from 1 to 4. However, the lower limit value of the number of carbon atoms of the alkylene group is 2 in the case of having a specific bond between carbon-carbon atoms.

Examples of the ring structure in Z¹ include the ring structures described above, and preferred forms are also the same. Q¹⁴ and Q²⁴ are directly bonded to the ring structure in Z¹, and thus, for example, there is no such case where an alkylene group is linked to the ring structure and Q¹⁴ and Q²⁴ are linked to the alkylene group.

The number of carbon atoms in the alkyl group of R^{e1}, R^{e2}, or R^{e3} is preferably from 1 to 6, more preferably from 1 to 3, and particularly preferably from 1 to 2 from the viewpoint of easily producing a compound.

The number of carbon atoms in the alkyl group moiety of the acyloxy group of R^{e2} is preferably from 1 to 6, more preferably from 1 to 3, and particularly preferably from 1 to 2 from the viewpoint of easily producing a compound.

h1 is preferably from 1 to 6, more preferably from 1 to 4, still more preferably 1 or 2, and particularly preferably 1 from the viewpoint of easily producing a compound and being further excellent in abrasion resistance of the surface treatment layer.

h2 is preferably from 2 to 6, more preferably from 2 to 4, and particularly preferably 2 or 3 from the viewpoint of easily producing a compound and being further excellent in abrasion resistance of the surface treatment layer.

Other forms of A include a Group (g2-8) (where, j1=d1+d3, and g1=d2×k3+d4×k3), a Group (g2-9) (where, j1=e1 and g1=e2×k3), a Group (g2-10) (where, j1=1 and g1=2×k3), a Group (g2-11) (where, j1=h1 and g1=h2×k3), a Group (g2-12) (where, j1=i1 and g1=i2×k3), a Group (g2-13) (where, j1=1 and g1=k3), or a Group (g2-14) (where, j1=1 and g1=i3×k3).

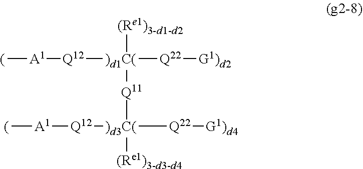

(-A¹-Q¹²-)ₑ₁C(R^{e2})₄₋ₑ₁₋ₑ₂(-Q²²-G¹)ₑ₂ (g2-9)

-A¹-Q¹³-N(-Q²³-G¹)₂ (g2-10)

(-A¹-Q¹⁴-)ₕ₁Z¹(-Q²⁴-G¹)ₕ₂ (g2-11)

(-A¹-Q¹⁵-)ᵢ₁Si(R^{e3})₄₋ᵢ₁₋ᵢ₂(-Q²⁵-G¹)ᵢ₂ (g2-12)

-A¹-Q²⁶-G¹ (g2-13)

-A¹-Q¹²-CH(-Q²²-G¹)—Si(R^{e3})₃₋ᵢ₃(-Q²⁵-G¹)ᵢ₃ (g2-14)

However, in Formulas (g2-8) to (g2-14), the A¹ side is bonded to Z, and the G¹ side is bonded to [—Si(R¹)ₙL₃₋ₙ].

G¹ is the following Group (g3), and two or more pieces of G¹ of A may be the same or different from each other. The reference numerals other than G¹ are the same as the reference numerals in Formulas (g2-1) to (g2-7).

—Si(R⁸)₃₋ₖ₃(-Q³-)ₖ₃ (g3)

However, in the Group (g3), the Si side is connected to Q²², Q²³, Q²⁴, Q²⁵, and Q²⁶, and the Q³ side is connected to [—Si(R¹)ₙL₃₋ₙ]. R⁸ is an alkyl group. Q³ is an alkylene group, a group having —C(O)NR⁶—, —C(O)—, —NR⁶— or —O— between carbon-carbon atoms of an alkylene group having two or more carbon atoms, or (OSi(R⁹)₂)ₚ—O—, and two or more pieces of Q³ may be the same or different from each other. k3 is 2 or 3. R⁶ is a hydrogen atom, an alkyl group having 1 to 6 carbon atoms, or a phenyl group. R⁹ is an alkyl group, a phenyl group, or an alkoxy group, and two pieces of R⁹ may be the same or different from each other. p is an integer from 0 to 5, and when p is two or more, two or more (OSi(R⁹)₂) may be the same or different from each other.

The number of carbon atoms in the alkylene group of Q³ is preferably from 1 to 30, more preferably from 1 to 20, still more preferably from 2 to 20, and may be from 2 to 10 or from 2 to 6 from the viewpoint of easily producing a compound and being further excellent in abrasion resistance of the surface treatment layer. Examples thereof include 2, 3, 8, 9, and 11. The number of carbon atoms may be from 1 to 10, from 1 to 6, or from 1 to 4. However, the lower limit value of the number of carbon atoms of the alkylene group is 2 in the case of having a specific bond between carbon-carbon atoms.

The number of carbon atoms in the alkyl group of R⁸ is preferably from 1 to 6, more preferably from 1 to 3, and still more preferably from 1 to 2 from the viewpoint of easily producing a compound.

The number of carbon atoms in the alkyl group of R⁹ is preferably from 1 to 6, more preferably from 1 to 3, and still more preferably from 1 to 2 from the viewpoint of easily producing a compound.

The number of carbon atoms in the alkoxy group of R⁹ is preferably from 1 to 6, more preferably from 1 to 3, and still more preferably from 1 to 2 from the viewpoint of being excellent in storage stability of the compound. p is preferably 0 or 1.

Examples of the compound of the present disclosure include a compound of the following formula. The compound of the following formula is preferable from the viewpoint of easy industrial production, easy handling, and being further excellent in water repellency and abrasion resistance of the surface treatment layer. R in the compound of the following formula is the same as [T-Z]p in Formula 1 described above, and preferred forms are also the same.

Examples of the compound in which A is a Group (g2-1) in Formula 1 include a compound of the following formula.

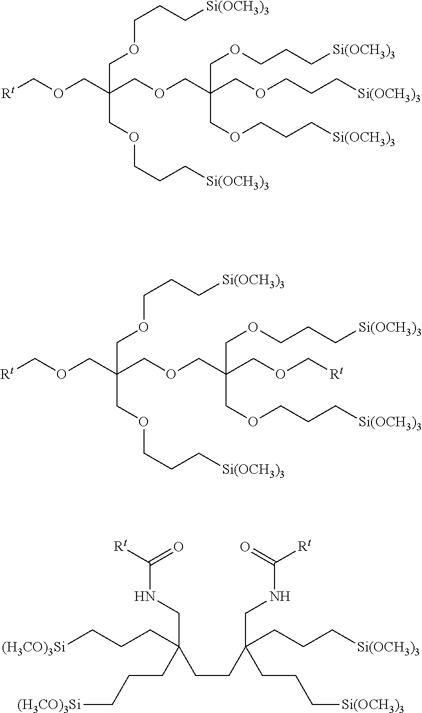

Examples of the compound in which A is a Group (g2-2) in Formula 1 include a compound of the following formula.

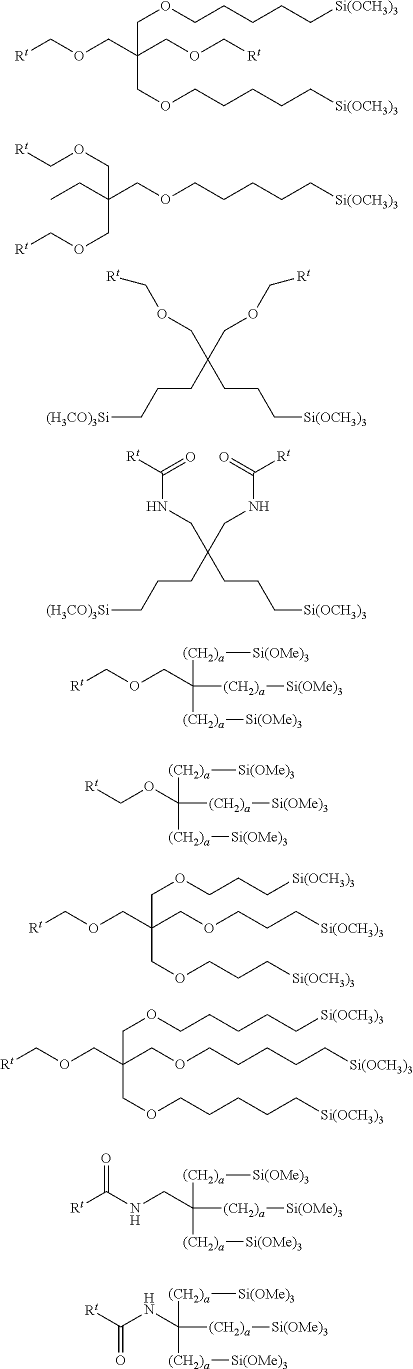

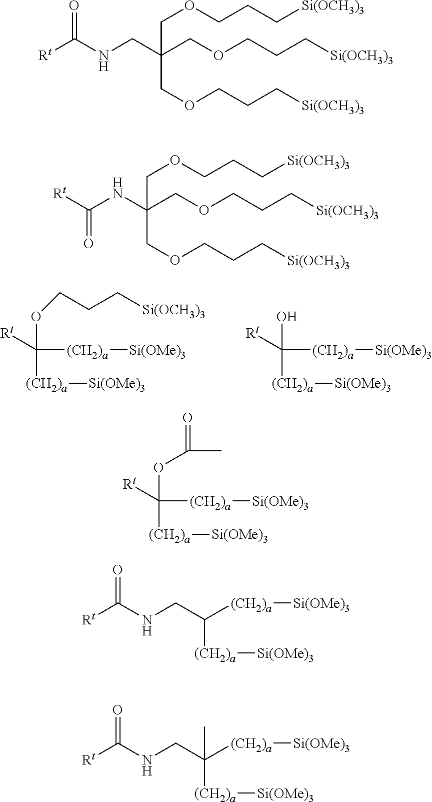

Examples of the compound in which A is a Group (g2-3) in Formula 1 include a compound of the following formula.

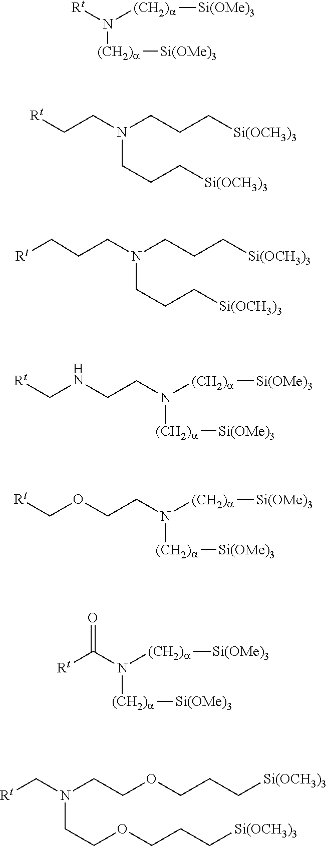

Examples of the compound in which A is a Group (g2-4) in Formula 1 include a compound of the following formula.

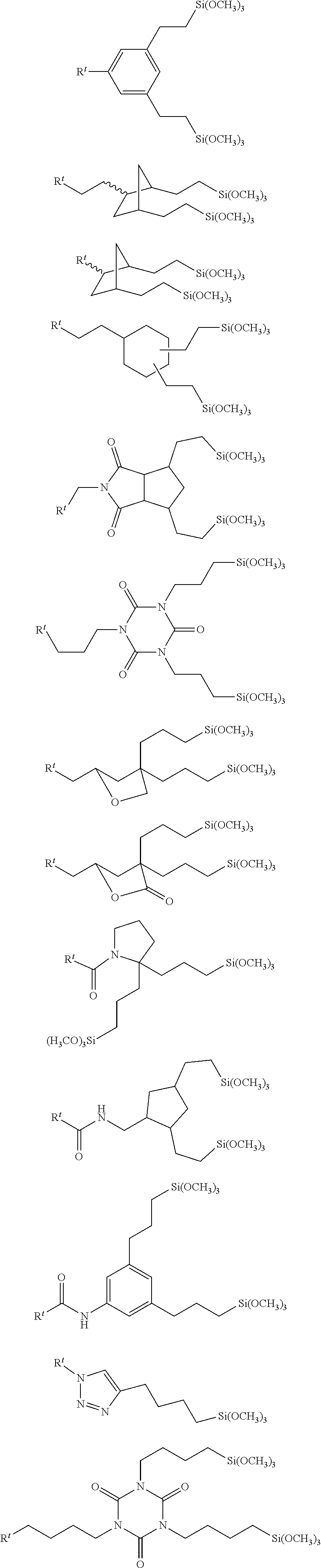

Examples of the compound in which is a Group (g2-5) in Formula 1 include a compound of the following formula.

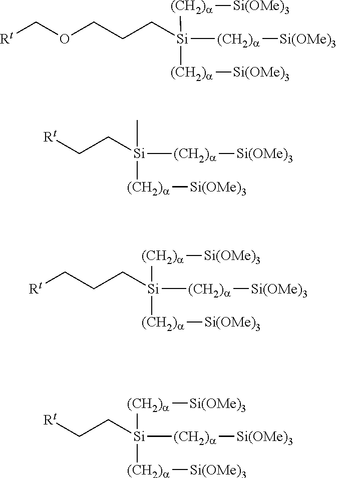

Examples of the compound in which A is a Group (g2-6) in Formula 1 include a compound of the following formula.

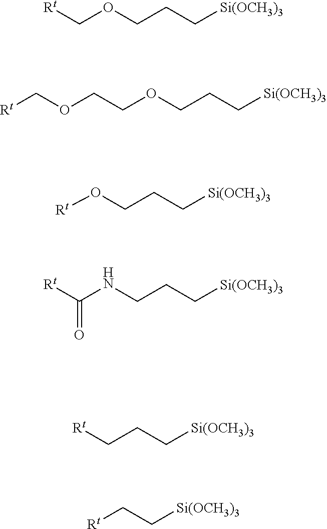

Examples of the compound in which A is a Group (g2-7) in Formula 1 include a compound of the following formula.

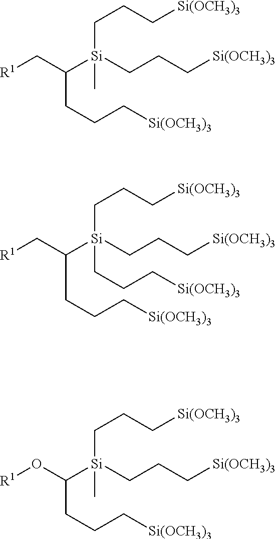

Examples of the compound in which A is a Group (g2-8) in Formula 1 include a compound of the following formula.

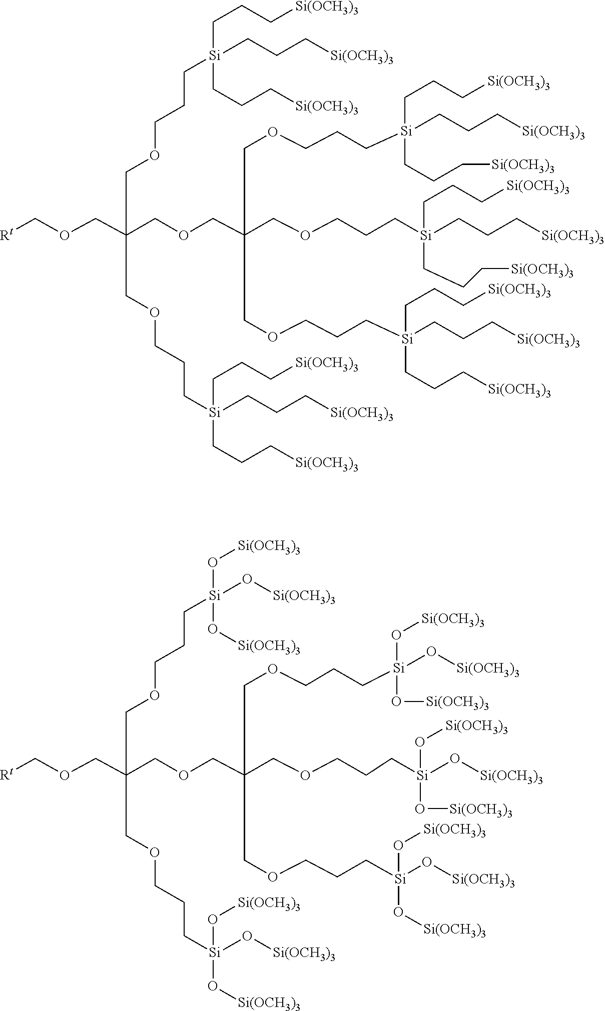

Examples of the compound in which A is a Group (g2-9) in Formula 1 include a compound of the following formula.

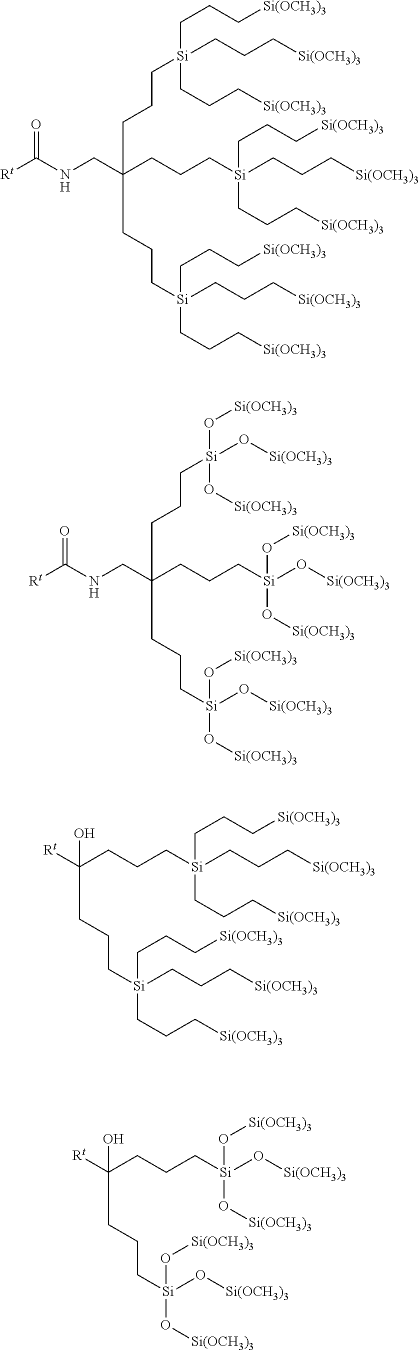

Examples of the compound in which A is a Group (g2-10) in Formula 1 include a compound of the following formula.

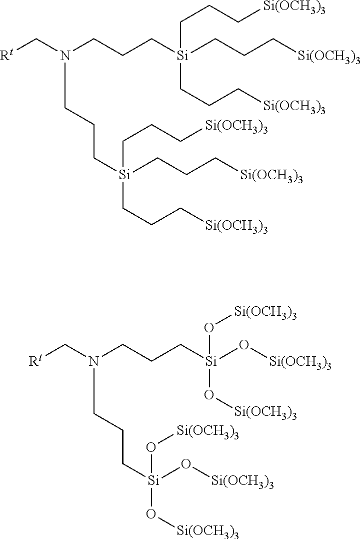

Examples of the compound in which A is a Group (g2-11) in Formula 1 include a compound of the following formula.

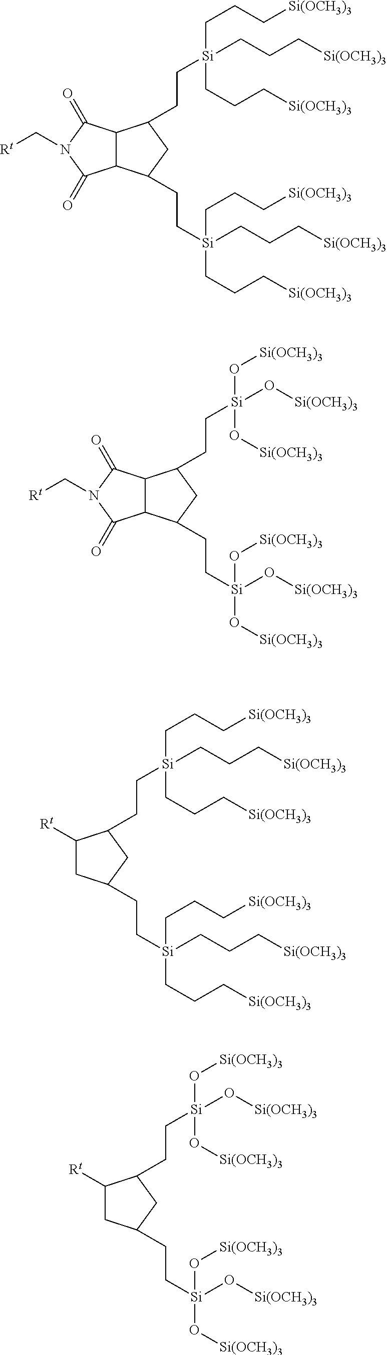

Examples of the compound in which A is a Group (g2-12) in Formula 1 include a compound of the following formula.

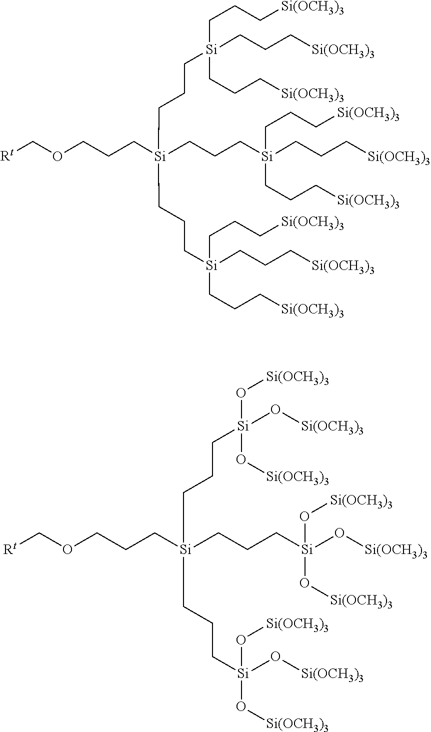

Examples of the compound in which A is a Group (g2-13) in Formula 1 include a compound of the following formula.

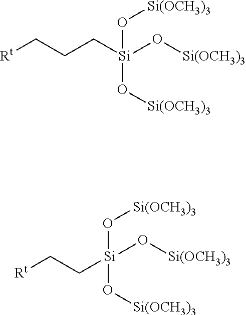

Examples of the compound in which A is a Group (g2-14) in Formula 1 include a compound of the following formula.

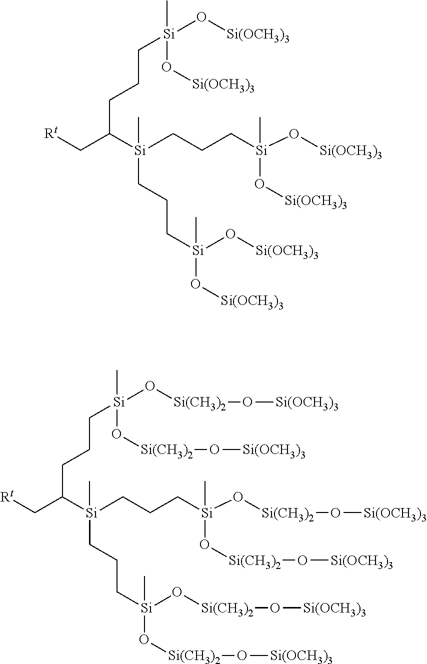

The compound of the present disclosure is preferably a compound represented by the following Formula 4.

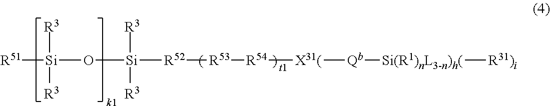

In Formula 4, R⁵¹ represents an alkyl group having two or more carbon atoms.

Each of R⁵² and R⁵⁴ independently represents an alkylene group.

R⁵³ represents —C(O)O—, —SO₂N(R^{d})—, —N(R^{d})SO₂—, —N(R^{d})C(O)—, or —C(O)N(R^{d})—.

R³ represents the same as R³ in Formula B1. k1 is the same as k1 in Formula B1.

The group represented by X³1(-Q^{b}-Si(R¹)ₙL₃₋ₙ)ₕ(—R³¹)ᵢ is the same as the group represented by X³¹(-Q^{b}-Si(R¹)ₙL₃₋ₙ)ₕ(—R³¹)ᵢ in Formula 3-1A.

t1 is 0 or 1.

A preferred embodiment of the alkyl group represented by R⁵¹ is as described in the section of the alkyl group.

The alkylene group represented by R⁵² may be linear, branched, or cyclic. The number of carbon atoms in the alkylene group is preferably from 1 to 30, more preferably from 1 to 20, still more preferably from 4 to 20, and particularly preferably from 5 to 15.

The alkylene group represented by R⁵⁴ may be linear, branched, or cyclic. The number of carbon atoms in the alkylene group is preferably from 1 to 20, more preferably from 1 to 10, still more preferably from 1 to 6, and particularly preferably from 1 to 3.

Examples of the compound of the present disclosure include the following compound. In the following formula, n is preferably from 9 to 50, more preferably from 11 to 30, and still more preferably from 11 to 25.

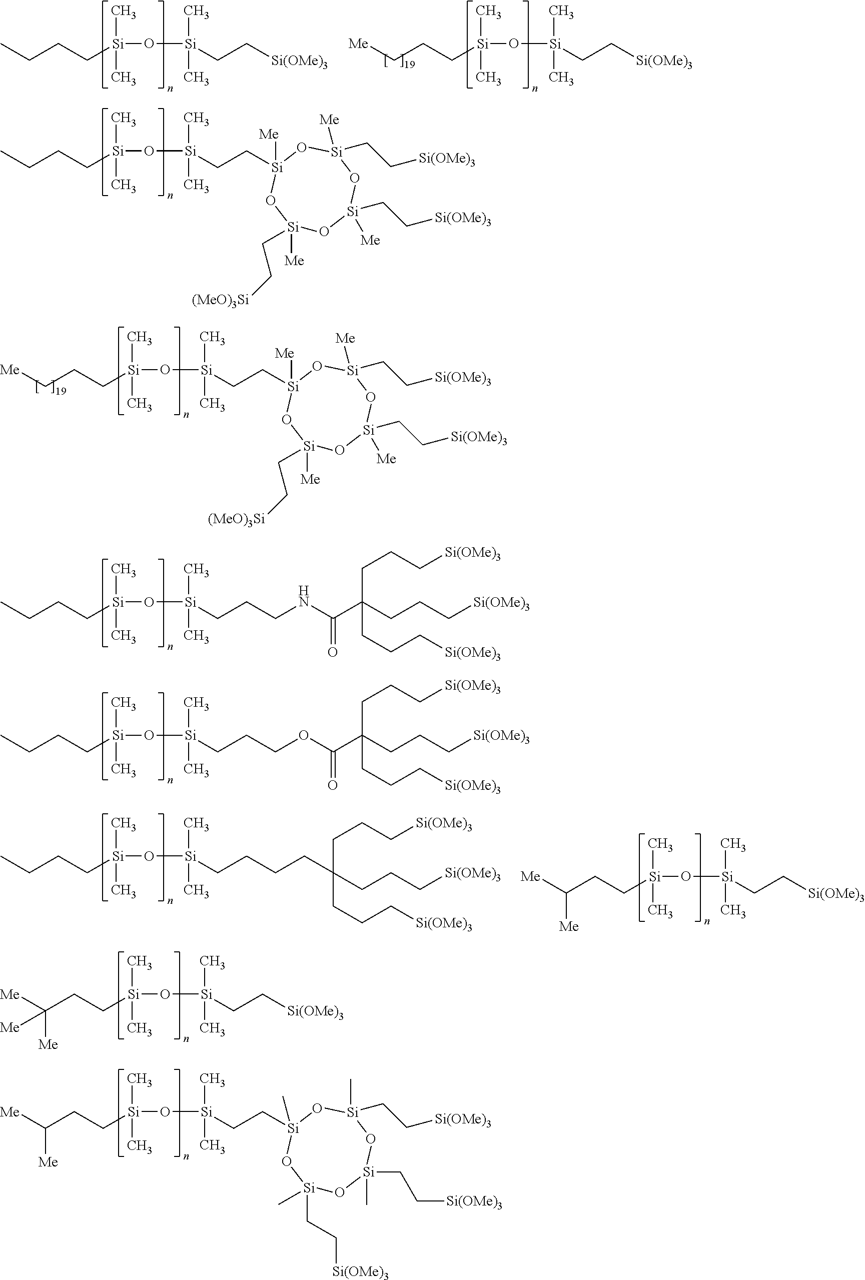

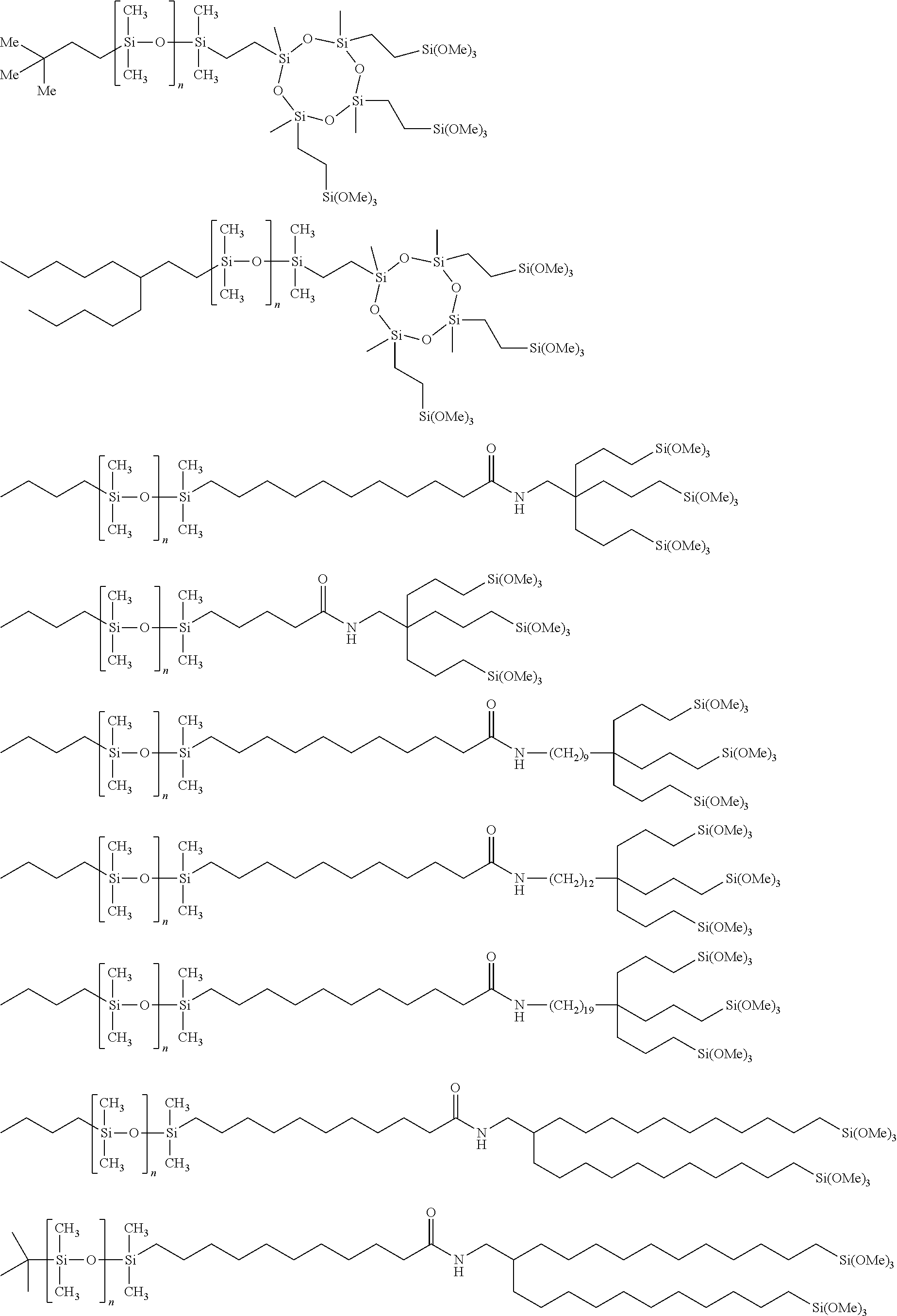

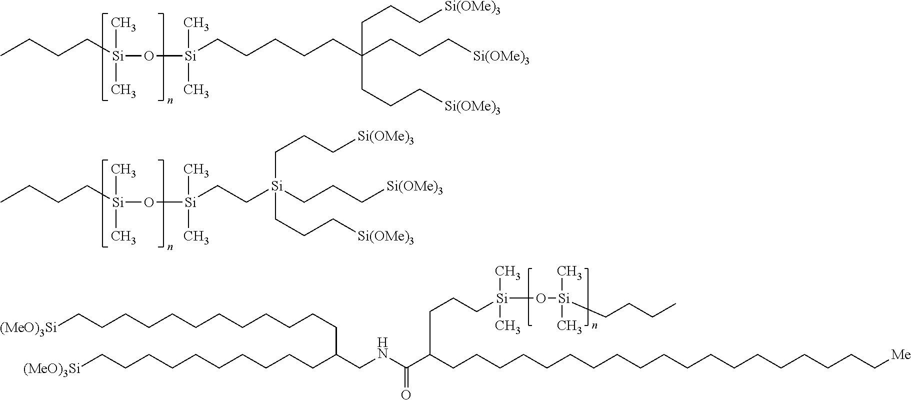

The number average molecular weight (Mn) of the compound of the present disclosure is preferably from 500 to 20,000, more preferably from 600 to 18,000, and still more preferably from 700 to 15,000.

When Mn is 500 or more, the abrasion resistance of the surface treatment layer is more excellent. When Mn is 20,000 or less, the viscosity is easily adjusted within an appropriate range, and the solubility is improved, and thus handleability at the time of film formation is excellent.

### [Composition]

The composition of the present disclosure may contain the compound of the present disclosure, and components other than the compound of the present disclosure are not particularly limited. The composition of the present disclosure preferably contains a compound of the present disclosure and a liquid medium. When the composition according to the present disclosure includes a liquid medium, the composition according to the present disclosure may be a solution, or may be a dispersion, as long as the composition is liquid.

The composition of the present disclosure may contain the compound of the present disclosure, and may contain impurities such as by-products generated in the step of producing the compound of the present disclosure.

The content rate of the compound of the present disclosure is preferably from 0.001 to 40% by mass, more preferably from 0.01 to 20% by mass, and still more preferably from 0.1 to 10% by mass with respect to the total amount of the composition of the present disclosure. In the case of the composition of the present disclosure used in the wet coating method, the content rate of the compound of the present disclosure may be from 0.01 to 10% by mass, from 0.02 to 5% by mass, from 0.03 to 3% by mass, or from 0.05 to 2% by mass with respect to the total amount of the composition of the present disclosure.

The liquid medium contained in the composition of the present disclosure may be of only one kind or two or more kinds.

The liquid medium is preferably an organic solvent.

Examples of the organic solvents include compounds composed only of hydrogen atoms and carbon atoms, and compounds composed only of hydrogen atoms, carbon atoms, and oxygen atoms, and specific examples thereof include hydrocarbon-based organic solvents, ketone-based organic solvents, ether-based organic solvents, ester-based organic solvents, glycol-based organic solvents, and alcohol-based organic solvents.

Specific examples of the hydrocarbon-based organic solvent include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of the ketone-based organic solvent include acetone, methyl ethyl ketone, methyl isobutyl ketone, diisobutyl ketone, cyclohexanone, 2-heptanone, 4-heptanone, 3,5,5-trimethyl-2-cyclohexene-1-one, and 3,3,5-trimethylcyclohexanone, and isophorone.

Specific examples of the ether-based organic solvent include diethyl ether, cyclopentyl methyl ether, tetrahydrofuran, and 1,4-dioxane.

Specific examples of the ester-based organic solvent include methyl acetate, ethyl acetate, propyl acetate, isopropyl acetate, butyl acetate, isobutyl acetate, tert-butyl acetate, amyl acetate, isoamyl acetate, ethyl 3-ethoxypropionate, ethyl lactate ethylene glycol monobutyl ether acetate, diethylene glycol monobutyl ether acetate, propylene glycol monomethyl ether acetate, dipropylene glycol methyl ether acetate, 3-methoxy-3-methylbutyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, propylene glycol monomethyl ether acetate, propylene glycol monomethyl ether propionate, propylene glycol monoethyl ether acetate, propylene glycol monobutyl ether acetate, propylene glycol monopropyl ether acetate, dipropylene glycol methyl ether acetate, 1,3-butylene glycol diacetate, 1,4-butanediol diacetate, 1,3-butylene glycol diacetate, 1,6-hexanediol diacetate, γ-butyrolactone, triacetin, and 2,2,4-trimethyl-1,3-pentanediol monoisobutyrate.

Specific examples of the glycol-based organic solvent include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monobutyl ether, propylene glycol monopropyl ether, ethylene glycol monoisopropyl ether, ethylene glycol monoethyl ether, ethylene glycol monotert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monomethyl ether, tripropylene glycol monobutyl ether, tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, ethylene glycol dibutyl ether, diethylene glycol diethyl ether, diethylene glycol dimethyl ether, dipropylene glycol dimethyl ether, diethylene glycol dibutyl ether, tetraethylene glycol dimethyl ether, dipropylene glycol dimethyl ether pentane, triethylene glycol dimethyl ether, and polyethylene glycol dimethyl ether.

Specific examples of the alcohol-based organic solvent include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4-methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Examples of the organic solvents include halogen-based organic solvents, nitrogen-containing compounds, sulfur-containing compounds, and siloxane compounds.

Specific examples of the halogen-based organic solvent include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Examples of the nitrogen-containing compound include nitrobenzene, acetonitrile, benzonitrile, N,N-dimethylformamide, N,N-dimethylacetamide, N-methylpyrrolidone, and 1,3-dimethyl-2-imidazolidinone.

Examples of the sulfur-containing compound include carbon disulfide and dimethyl sulfoxide.

Examples of the siloxane compound include hexamethyldisiloxane, octamethyltrisiloxane, and decamethyltetrasiloxane.

The content rate of the liquid medium is preferably from 60 to 99.999% by mass, more preferably from 80 to 99.99% by mass, and still more preferably from 90 to 99.9% by mass with respect to the total amount of the composition of the present disclosure. In the case of the composition of the present disclosure used in the wet coating method, the content rate of the liquid medium may be from 90 to 99.99% by mass, from 95 to 99.98% by mass, from 97 to 99.97% by mass, or from 98 to 99.95% by mass with respect to the total amount of the composition of the present disclosure.

The composition of the present disclosure may contain other components in addition to the compound of the present disclosure and the liquid medium as long as the effects of the present disclosure are not impaired.

Examples of other components include known additives such as acid catalysts and basic catalysts that promote hydrolysis and condensation reaction of reactive silyl groups.

In addition, examples of other components include metal compounds having hydrolyzable groups (hereinafter, the metal compound having a hydrolyzable group is also referred to as “specific metal compound”). The composition of the present disclosure contains a specific metal compound, thereby allowing to further improve slippage and antifouling properties of the surface treatment layer. Examples of the specific metal compound include the following formulas (M1) to (M3).

M(X^{b1})ₘ₁(X^{b2})ₘ₂(X^{b3})ₘ₃ (M1)

Si(X^{b4})(X^{b5})₃ (M2)

(X^{b6})₃Si—(Y^{b1})—Si(X^{b7})₃ (M3)

In Formula (M1),
M represents a trivalent or tetravalent metal atom.
Each X^{b1} independently represents a hydrolyzable group.
Each X^{b2} independently represents a siloxane backbone-containing group.
Each X^{b3} independently represents a hydrocarbon chain-containing group.
m1 represents an integer from 2 to 4,
each of m2 and m3 independently represents an integer from 0 to 2,
when M is a trivalent metal atom, m1+m2+m3 is 3, and when M is a tetravalent metal atom, m1+m2+m3 is 4.

In Formula (M2),
X^{b4} represents a hydrolyzable silane oligomer residue.
X^{b5} each independently represents a hydrolyzable group or an alkyl group having 1 to 4 carbon atoms.

In Formula (M3),
Each of X⁶ and X^{b7} independently represents a hydrolyzable group or a hydroxyl group.
Y^{b1} represents a divalent organic group.

In Formula (M1), the metal represented by M also includes metalloids such as Si and Ge. M is preferably a trivalent metal or a tetravalent metal, more preferably Al, Fe, In, Hf, Si, Ti, Sn, and Zr, still more preferably Al, Si, Ti, and Zr, and particularly preferably Si.

Examples of the hydrolyzable group represented by X^{b1} in Formula (M1) include the same group as the hydrolyzable group represented by L in [—Si(R¹)ₙL₃₋ₙ] in the reactive silyl group.

The siloxane backbone-containing group represented by X^{b2} has a siloxane unit (—Si—O—), and may be linear or branched. The siloxane unit is preferably a dialkylsilyloxy group, and examples thereof include a dimethylsilyloxy group and a diethylsilyloxy group. The number of repetitions of the siloxane unit in the siloxane backbone-containing group is 1 or more, preferably from 1 to 5, more preferably from 1 to 4, and still more preferably from 1 to 3.

The siloxane backbone-containing group may contain a divalent hydrocarbon group in a portion of the siloxane backbone. Specifically, some oxygen atoms of the siloxane backbone may be replaced by divalent hydrocarbon groups. Examples of the divalent hydrocarbon groups include alkylene groups such as a methylene group, an ethylene group, a propylene group, and a butylene group.

A hydrolyzable group, a hydrocarbon group (preferably an alkyl group), or the like may be bonded to the silicon atom at the end of the siloxane backbone-containing group.

The number of elements of the siloxane backbone-containing group is preferably 100 or less, more preferably 50 or less, still more preferably 30 or less. The number of elements is preferably 10 or more.

The siloxane backbone-containing group is preferably a group represented by *—(O—Si(CH₃)₂)ₙCH₃, where n represents an integer from 1 to 5, and * represents a bonding site with an adjacent atom.

The hydrocarbon chain-containing group represented by X^{b3} may be a group consisting only of a hydrocarbon chain, or may be a group having an etheric oxygen atom between carbon-carbon atoms of the hydrocarbon chain. The hydrocarbon chain may be linear or branched, and is preferably linear. The hydrocarbon chain may be a saturated hydrocarbon chain or an unsaturated hydrocarbon chain, and is preferably a saturated hydrocarbon chain. The number of carbon atoms in the hydrocarbon chain-containing group is preferably from 1 to 3, more preferably from 1 to 2, and still more preferably 1. The hydrocarbon chain-containing group is preferably an alkyl group, and more preferably a methyl group, an ethyl group, or a propyl group.

m1 is preferably 3 or 4.

As the compound represented by Formula (M1), compounds represented by the following formulas (M1-1) to (M1-5) in which M is Si are preferable, and a compound represented by Formula (M1-1) is more preferable. The compound represented by Formula (M1-1) is preferably tetraethoxysilane, tetramethoxysilane, or triethoxymethylsilane.

Si(X^{b1})₄ (M1-1)

CH₃—Si(X^{b1})₃ (M1-2)

C₂H₅—Si(X^{b1})₃ (M1-3)

n-C₃H₇—Si(X^{b1})₃ (M1-4)

(CH₃)₂CH—Si(X^{b1})₃ (M1-5)

In Formula (M2), the number of silicon atoms contained in the hydrolyzable silane oligomer residue represented by X^{b4} is preferably 3 or more, more preferably 5 or more, still more preferably 7 or more. The number of the silicon atoms is preferably 15 or less, more preferably 13 or less, still more preferably 10 or less.

The hydrolyzable silane oligomer residue may have an alkoxy group bonded to a silicon atom. Examples of the alkoxy group include a methoxy group, an ethoxy group, a propoxy group, and a butoxy group, and a methoxy group and an ethoxy group are preferable. The hydrolyzable silane oligomer residue may have one kind or two or more kinds of these alkoxy groups, and preferably has one kind.

Examples of the hydrolyzable silane oligomer residue include (C2H₅O)₃Si—(OSi(OC₂H₅)₂)₄O—* where * represents a binding site with an adjacent atom.

Examples of the hydrolyzable group represented by X^{b5} in Formula (M2) include the same group as the hydrolyzable group represented by L in [—Si(R¹)ₙL₃₋ₙ] in the reactive silyl group, a cyano group, a hydrogen atom, and an allyl group, and an alkoxy group or an isocyanato group is preferable. The alkoxy group is preferably an alkoxy group having 1 to 4 carbon atoms.

X^{b5} is preferably a hydrolyzable group.

Examples of the compound represented by Formula (M2) include (H₅C₂O)₃—Si—(OSi(OC₂H₅)₂)₄OC₂H₅.

The compound represented by Formula (M3) is a compound having reactive silyl groups at both terminals of a divalent organic group, that is, bissilane.

Examples of the hydrolyzable group represented by X^{b6} and X^{b7} in Formula (M3) include an alkoxy group, an acyloxy group, a ketoxime group, an alkenyloxy group, an amino group, an aminoxy group, an amide group, an isocyanato group, and a halogen atom, and an alkoxy group and an isocyanato group are preferable. As the alkoxy group, an alkoxy group having 1 to 4 carbon atoms is preferable, and a methoxy group and an ethoxy group are more preferable.

In Formula (M3), X^{b6} and X^{b7} may be the same group or different groups from each other. From the viewpoint of availability, X^{b6} and X^{b7} are preferably the same group.

In Formula (M3), Y^{b1} is a divalent organic group linking reactive silyl groups at both terminals. The number of carbon atoms in Y^{b1} of the divalent organic group is preferably from 1 to 8, and more preferably from 1 to 3.

Examples of Y^{b1} include an alkylene group, a phenylene group, and an alkylene grou p having an etheric oxygen atom between carbon atoms. Examples thereof include —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH 2C(CH₃)₂CH₂—, —C(CH₃)₂CH₂CH₂C(CH₃)₂—, —CH₂CH₂OCH₂CH₂—, —CH₂CH₂CH₂OCH₂CH₂CH₂—, —CH(CH₃)CH₂OCH₂CH(CH₃)—, and —C₆H₄—.

Examples of the compound represented by Formula (M3) include (CH₃O)₃Si(CH₂)₂Si(OCH₃)₃, (C₂H₅O)₃Si(CH₂)₂Si(OC₂H₅)₃, (OCN)₃Si(CH₂)₂Si(NCO)₃, Cl₃Si(CH₂)₂SiCl₃, (CH₃O)₃Si(CH₂)₆Si(OCH₃)₃, and (C₂H₅O)₃Si(CH₂)₆Si(OC₂H₅)₃.

The content rate of other components that may be contained in the composition of the present disclosure is preferably 10% by mass or less, and more preferably 1% by mass or less, with respect to the total amount of the composition of the present disclosure. When the composition of the present disclosure contains the specific metal compound, the content rate of the specific metal compound is preferably from 0.01 to 30% by mass, more preferably from 0.01 to 10% by mass, and still more preferably 0.05 to 5% by mass with respect to the total amount of the composition of the present disclosure.

The total content rate (hereinafter, also referred to as “solid content concentration”) of the compound of the present disclosure and other components is preferably from 0.001 to 40% by mass, more preferably from 0.01 to 20% by mass, and still more preferably from 0.1 to 10% by mass with respect to the total amount of the composition of the present disclosure. The solid content concentration of the composition of the present disclosure is a value calculated from the mass of the composition before heating and the mass after heating in a convection dryer at 120° C. for 4 hours.

The composition of the present disclosure contains a liquid medium, and thus it is useful as a coating application and can be used as a coating liquid.

### [Surface Treatment Agent]

In one aspect, the surface treatment agent of the present disclosure includes a compound of the present disclosure. In addition, the surface treatment agent of the present disclosure may contain the compound of the present disclosure and a liquid medium. The surface treatment agent of the present disclosure may be the composition of the present disclosure. Preferred embodiments of the liquid medium contained in the surface treatment agent are the same as the preferred embodiments of the liquid medium contained in the composition of the present disclosure.

The compound of the present disclosure contains an alkyl group having two or more carbon atoms, an organopolysiloxane residue, and a reactive silyl group. Therefore, using a surface treatment agent containing the compound of the present disclosure allows forming a surface treatment layer excellent in water repellency and abrasion resistance.

The surface treatment agent of the present disclosure is particularly preferably used for an optical member.

### [Article]

In one aspect, an article of the present disclosure includes a substrate, a surface treatment layer disposed on the substrate, and a surface treatment layer surface-treated with the surface treatment agent of the present disclosure.

The surface treatment layer may be formed on a portion of the surface of the substrate, or may be formed on the entire surface of the substrate. The surface treatment layer may spread in a film shape on the surface of the substrate, or may be scattered in a dot shape.

In the surface treatment layer, the compound of the present disclosure is included in a state in which hydrolysis of a portion or all of the reactive silyl group has progressed and a dehydration condensation reaction of the silanol group has progressed.

The thickness of the surface treatment layer is preferably from 1 to 100 nm, and more preferably from 1 to 50 nm. When the thickness of the surface treatment layer is 1 nm or more, the effect of the surface treatment is easily sufficiently obtained. When the thickness of the surface treatment layer is 100 nm or less, utilization efficiency is high. The thickness of the surface treatment layer can be calculated from the vibration period of the interference pattern by obtaining the interference pattern of the reflected X-ray by the X-ray reflectance method with an X-ray diffractometer for thin film analysis (product name “ATX-G”, manufactured by RIGAKU Corporation).

The kind of the substrate is not particularly limited, and examples thereof include a substrate required to be imparted with water repellency. As the substrate, for example, a substrate that may be used by being brought into contact with another article (for example, astylus) or a human finger; a substrate that is hung by human fingers during operation; and a substrate that may be placed on other articles (for example, a placing table).

Examples of the material of the substrate include metal, resin, glass, sapphire, ceramic, stone, fiber, nonwoven fabric, paper, wood, natural leather, artificial leather, and composite materials thereof. The glass may be chemically strengthened.

Examples of the substrates include building materials, decorative building materials, interior goods, transportation equipment (for example, automobiles), signboards, bulletin boards, drinking vessels, tableware, water tanks, ornamental instruments (for example, frames, boxes), laboratory instruments, furniture, textile products, and packaging containers; glass or resin used for art, sports, games, or the like; and glass or resin used for exterior portions (excluding a display unit) in a device such as a mobile phone (for example, a smartphone), a portable information terminal, a game machine, or a remote controller. The shape of the substrate may be a plate shape or a film shape.

As the substrate, a substrate for a touch panel, a substrate for a display, and a spectacle lens are suitable, and a substrate for a touch panel is particularly suitable. The material of the substrate for a touch panel is preferably glass or a transparent resin.

The substrate may be a substrate having one surface or both surfaces subjected to a surface treatment such as a corona discharge treatment, a plasma treatment, or a plasma graft polymerization treatment. The substrate subjected to the surface treatment is more excellent in adhesion of the surface treatment layer, and the abrasion resistance of the surface treatment layer is further improved. Therefore, it is preferable to subject the surface of the substrate on the side in contact with the surface treatment layer to surface treatment. The substrate subjected to the surface treatment, when an underlayer described later is provided, has more excellent adhesion to the underlayer, and the abrasion resistance of the surface treatment layer is further improved. Therefore, when the underlayer is provided, it is preferable to subject the surface of the substrate on the side in contact with the underlayer to the surface treatment.

The surface treatment layer may be provided directly on the surface of the substrate, or the underlayer may be provided between the substrate and the surface treatment layer. From the viewpoint of further improving the water repellency and abrasion resistance of the surface treatment layer, the article of the present disclosure preferably includes a substrate, an underlayer disposed on the substrate, and a surface treatment layer disposed on the underlayer and surface-treated with the surface treatment agent of the present disclosure.

The underlayer is preferably a layer containing an oxide containing silicon and at least one specific element selected from the group consisting of a Group 1 element, a Group 2 element, a Group 4 element, a Group 5 element, a Group 13 element, and a Group 15 element of the periodic table.

The Group 1 element (hereinafter, also referred to as “Group 1 element”) in the periodic table is lithium, sodium, potassium, rubidium, and cesium. As the Group 1 element, lithium, sodium, and potassium are preferable, and sodium and potassium are more preferable from the viewpoint that the surface treatment layer can be more uniformly formed on the underlayer without defects, or the variation in the composition of the underlayer between samples is further suppressed. The underlayer may contain two or more kinds of the Group 1 elements.

The Group 2 element (hereinafter, also referred to as “Group 2 element”) in the periodic table is beryllium, magnesium, calcium, strontium, and barium. As the Group 2 element, magnesium, calcium, and barium are preferable, and magnesium and calcium are more preferable from the viewpoint that the surface treatment layer can be more uniformly formed on the underlayer without defects, or the variation in the composition of the underlayer between samples is further suppressed. The underlayer may contain two or more kinds of Group 2 elements.

The Group 4 element (hereinafter, also referred to as “Group 4 element”) in the periodic table is titanium, zirconium, and hafnium. As the Group 4 element, titanium and zirconium are preferable, and titanium is more preferable from the viewpoint that the surface treatment layer can be more uniformly formed on the underlayer without defects, or from the viewpoint that variations in the composition of the underlayer between samples are further suppressed. The underlayer may contain two or more kinds of Group 4 elements.

The Group 5 element (hereinafter, also referred to as “Group 5 element”) in the periodic table is vanadium, niobium, and tantalum. As the Group 5 element, vanadium is particularly preferable from the viewpoint of more excellent abrasion resistance of the surface treatment layer. The underlayer may contain two or more kinds of Group 5 elements.

The Group 13 element (hereinafter, also referred to as “Group 13 element”) in the periodic table is boron, aluminum, gallium, and indium. As the group 13 element, boron, aluminum, and gallium are preferable, and boron and aluminum are more preferable from the viewpoint that the surface treatment layer can be more uniformly formed on the underlayer without defects or the variation in the composition of the underlayer between samples is further suppressed. The underlayer may contain the two or more kinds of Group 13 elements.

The Group 15 element (hereinafter, also referred to as “Group 15 element”) in the periodic table is nitrogen, phosphorus, arsenic, antimony, and bismuth. As a group 15 element, phosphorus, antimony, and bismuth are preferable, and phosphorus and bismuth are more preferable, from the viewpoint that the surface treatment layer can be more uniformly formed on the underlayer without defects, or from the viewpoint that variation in the composition of the underlayer between samples is further suppressed. The underlayer may contain two or more kinds of Group 15 elements.

As the specific element contained in the underlayer, a Group 1 element, a Group 2 element, and a Group 13 element are preferable because the abrasion resistance of the surface treatment layer is more excellent, and a Group 1 element and a Group 2 element are more preferable, and a Group 1 element is still more preferable.

As the specific element, only one kind of element may be contained, or two or more kinds of elements may be contained.

An oxide contained in the underlayer may be a mixture of oxides of the above elements (silicon and specific elements) singly (for example, a mixture of a silicon oxide and an oxide of a specific element), a composite oxide containing two or more kinds of the above elements, or a mixture of an oxide of the above elements singly and a composite oxide.

The ratio of the total molar concentration of the specific element in the underlayer to the molar concentration of silicon in the underlayer (specific element/silicon) is preferably from 0.02 to 2.90, more preferably from 0.10 to 2.00, and still more preferably from 0.20 to 1.80 from the viewpoint of being more excellent in abrasion resistance of the surface treatment layer.

The molar concentration (mol %) of each element in the underlayer can be measured by, for example, depth direction analysis by X-ray photoelectron spectroscopy (XPS) with ion sputtering.

The underlayer may be a single layer or a multilayer. The underlayer may have irregularities on the surface.

The thickness of the underlayer is preferably from 1 to 100 nm, more preferably from 1 to 50 nm, and still more preferably from 2 to 20 nm. When the thickness of the underlayer is the above lower limit value or more, the adhesion of the surface treatment layer by the underlayer is further improved, and the abrasion resistance of the surface treatment layer is further excellent. When the thickness of the underlayer is the above upper limit value or less, the abrasion resistance of the underlayer itself is excellent.

The thickness of the underlayer is measured by observing a cross-section of the underlayer with a transmission electron microscope (TEM).

The underlayer can be formed by, for example, a vapor deposition method with a vapor deposition material or a wet coating method.

The vapor deposition material used in the vapor deposition method preferably contains silicon and an oxide containing a specific element.

Specific examples of the form of the vapor deposition material include a powder, a melt, a sintered body, a granulated body, and a crushed body, and from the viewpoint of handleability, the melt, the sintered body, and the granulated body are preferable.

The melt body is a solid obtained by melting a powder of the vapor deposition material at a high temperature and then cooling and solidifying the powder. The sintered body is a solid obtained by firing a powder of the vapor deposition material, and a molded body obtained by press-molding the powder may be used instead of the powder of the vapor deposition material as necessary. The granulated body is a solid obtained by kneading a powder of a vapor deposition material and a liquid medium (for example, water or an organic solvent) to provide particles and then drying the particles.

The deposition material can be produced, for example, by the following method.
A method of mixing a powder of silicon oxide and a powder of an oxide of a specific element to provide a powder of a vapor deposition material.
A method of kneading the powder of the vapor deposition material and water to provide particles, and then drying the particles to provide a granulated body of the vapor deposition material.
A method of drying a mixture obtained by mixing a powder containing silicon (for example, a powder made of a silicon oxide, silica sand, or silica gel), a powder containing a specific element (for example, a powder of an oxide of a specific element, a carbonate, a sulfate, a nitrate, an oxalate, or a hydroxide), and water, and then firing the dried mixture or a molded body obtained by press-molding the dried-mixture to provide a sintered body.
A method of melting, at a high temperature, a powder containing silicon (for example, a powder made of a silicon oxide, silica sand, or silica gel) and a powder containing a specific element (for example, a powder of an oxide of a specific element, a carbonate, a sulfate, a nitrate, an oxalate, or a hydroxide), and then cooling and solidifying the melted powders to provide a melt.

Specific examples of the vapor deposition method with the vapor deposition material include a vacuum vapor deposition method. The vacuum vapor deposition method is a method of evaporating a vapor deposition material in a vacuum chamber and adhering to a surface of a substrate.

The temperature (for example, the temperature of the boat on which the vapor deposition material is disposed when a vacuum vapor deposition apparatus is used) during vapor deposition is preferably from 100 to 3,000° C., and more preferably from 500 to 3,000° C.

The pressure (for example, the pressure in a tank in which the vapor deposition material is disposed when a vacuum vapor deposition apparatus is used) during vapor deposition is preferably 1 Pa or less, and more preferably 0.1 Pa or less.

When the underlayer is formed with the vapor deposition material, one vapor deposition material may be used, or two or more kinds of vapor deposition materials containing different elements may be used.

Specific examples of the evaporation method of the vapor deposition material include a resistance heating method of melting and evaporating the vapor deposition material on a resistance heating boat made of a high melting point metal, and an electron gun method of irradiating the vapor deposition material with an electron beam and directly heating the vapor deposition material to melt the surface and evaporate the vapor deposition material. As a method of evaporating the vapor deposition material, the electron gun method is preferable from the viewpoint that a high melting point substance can be locally heated and thus can also be evaporated, and from the viewpoint that there is no possibility of reaction with a container or mixing of impurities because a portion that is not hit by an electron beam is at a low temperature.

As the evaporation method of a vapor deposition material, a plurality of boats may be used, or all vapor deposition materials may be placed in a single boat and used. The vapor deposition method may be co-vapor deposition, alternate vapor deposition, or the like. Specific examples thereof include an example in which silica and a specific source are mixed in the same boat and used, an example in which silica and a specific element source are placed in separate boats and co-deposited, and an example in which silica and a specific element source are placed in separate boats and alternately deposited. Conditions, order, and the like of vapor deposition are appropriately selected depending on the configuration of the underlayer.

In the wet coating method, it is preferable to form an underlayer on a substrate by a wet coating method with a coating liquid containing a compound containing silicon, a compound containing a specific element, and a liquid medium.

Specific examples of the silicon compound include silicon oxide, silicic acid, and partial condensates of silicic acid, alkoxysilane, and partial hydrolysis condensates of alkoxysilane.

Specific examples of the compound containing a specific element include an oxide of the specific element, an alkoxide of the specific element, a carbonate of the specific element, a sulfate of the specific element, a nitrate of the specific element, an oxalate of the specific element, and a hydroxide of the specific element.

Examples of the liquid medium include those similar to the liquid medium contained in the composition of the present disclosure.

The content rate of the liquid medium is preferably from 0.01 to 20% by mass, and more preferably from 0.1 to 10% by mass with respect to the total amount of the coating liquid used for forming the underlayer.

Specific examples of the wet coating method of forming the underlayer include a spin coating method, a wipe coating method, a spray coating method, a squeegee coating method, a dip coating method, a die coating method, an inkjet method, a flow coating method, a roll coating method, a casting method, a Langmuir-Brodgett method, and a gravure coating method.

It is preferable to wet coat the coating liquid and then dry the coating film. The drying temperature of the coating film is preferably from 20 to 200° C., and more preferably from 80 to 160° C.

The article of the present disclosure is preferably an optical member. Examples of the optical member include a car navigation, a mobile phone, a smartphone, a digital camera, a digital video camera, a PDA, a portable audio player, a car audio, a game machine, a spectacle lens, a camera lens, a lens filter, sunglasses, a medical instrument such as a stomach camera, a copying machine, a PC, a display (for example, a liquid crystal display, an organic EL display, a plasma display, or a touch panel display), a touch panel, a protective film, and an antireflection film. In particular, the article is preferably a display or a touch panel.

### [Method of Producing Article]

The method of producing an article of the present disclosure is, for example, a method of producing an article in which a surface treatment layer is formed on a substrate by performing a surface treatment on the substrate with the surface treatment agent of the present disclosure. Examples of the surface treatment include a dry coating method and a wet coating method.

Examples of the dry coating method include methods such as vacuum deposition, CVD, and sputtering. As the dry coating method, a vacuum vapor deposition method is preferable from the viewpoint of suppressing decomposition of the compound and convenience of the apparatus. At the time of vacuum deposition, a pellet-shape substance may be used which is obtained by impregnating a metal porous body of iron, steel, or the like with the compound of the present disclosure. A pellet-shaped substance may be used which is impregnated with the compound of the present disclosure by impregnating a metal porous body such as iron or steel with a composition containing the compound of the present disclosure and a liquid medium and drying the liquid medium.

Examples of the wet coating method include a spin coating method, a wipe coating method, a spray coating method, a squeegee coating method, a dip coating method, a die coating method, an inkjet method, a flow coating method, a roll coating method, a casting method, a Langmuir-Blodgett method, and a gravure coating method.

In order to improve the abrasion resistance of the surface treatment layer, an operation for promoting the reaction between the compound of the present disclosure and the substrate may be performed as necessary. Examples of the operation include heating, humidification, and light irradiation.

For example, the substrate on which the surface treatment layer is formed can be heated in the atmosphere having moisture to promote reactions such as a hydrolysis reaction of a hydrolyzable group, a reaction between a hydroxyl group or the like on the surface of the substrate and a silanol group, and generation of a siloxane bond by a condensation reaction of a silanol group.

After the surface treatment, the compound in the surface treatment layer, which is not chemically bonded to another compound or the substrate, may be removed as necessary. Examples of the removal method include a method of pouring a solvent on the surface treatment layer and a method of wiping the surface treatment layer with a cloth soaked with the solvent.

### EXAMPLES

Hereinafter, the present invention will be described in more detail with reference to Examples, but the present invention is not limited to these Examples. “Me” is a methyl group, and “n-Bu” is an n-butyl group.

### [Synthesis of Compound 1B]

1-Dococene (2.0 g) and 1,3-bistrifluoromethylbenzene (50 g) were added to monodispersed hydride-terminated polydimethylsiloxane (20 g, manufactured by Gelest Inc., product number: DMS-Hml5) having an average molecular weight of about 3,000, and was stirred. Thereafter, a toluene solution (platinum content rate: 3% by mass, 0.1 g) of platinum/1,3-divinyl-1, 1,3,3-tetramethyldisiloxane complex and aniline (0.1 g) were added, and heated and stirred at 100° C. for 4 hours. After cooling to 25° C., flash column chromatography (developing solvent:ethyl acetate/hexane) with silica gel was performed to provide 7.5 g of a Compound 1A. The structure of the Compound 1A was confirmed from the following NMR data. In the Compound 1A, the average value of n was 40.

¹H-NMR (500 MHz, Chloroform-d) δ 3.60 (s, 1H), 1.39-1.14 (m, 40H), 0.92-0.78 (m, 3H), 0.63-0.22 (m, 248H).

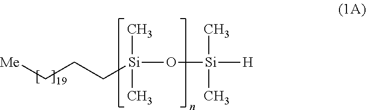

Vinyltrimethoxysilane (0.3 g) and 1,3-bistrifluoromethylbenzene (10 g) were added to the Compound 1A (3.0 g), and stirred, and then, a toluene solution of platinum/1,3-divinyl-1,1,3,3-tetramethyldisiloxane complex (platinum content rate 3% by mass, 0.1 g) and aniline (0.1 g) were added, and was stirred at 40° C. for 24 hours. The solvent was distilled off under reduced pressure to provide 3.1 g of a Compound 1B. The structure of the Compound 1B was confirmed from the following NMR data. In the Compound 1B, the average value of n was 40.

¹H-NMR (500 MHz, Chloroform-d) δ 3.58 (s, 9H), 1.44-1.14 (m, 40H), 0.94-0.81 (m, 3H), 0.72-0.10 (m, 252H).

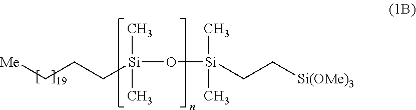

### [Synthesis of Compound 2B]

3-Methyl-1-butene (about 15% by mass of dichloromethane solution, about 2.5 mol/L) (3.0 g) and 1,3-bistrifluoromethylbenzene (50 g) were added to monodispersed hydride-terminated polydimethylsiloxane (20 g, manufactured by Gelest Inc., product number: DMS-Hml5) having an average molecular weight of about 3,000, and was stirred. Thereafter, a toluene solution (platinum content rate: 3% by mass, 0.1 g) of platinum/1,3-divinyl-1, 1,3,3-tetramethyldisiloxane complex and aniline (0.1 g) were added, and heated and stirred at 40° C. for 24 hours. After cooling to 25° C., flash column chromatography (developing solvent: ethyl acetate/hexane) with silica gel was performed to provide 7.0 g of a Compound 2A. The structure of the Compound 2A was confirmed from the following NMR data. In the Compound 2A, the average value of n was 40.

¹H-NMR (500 MHz, Chloroform-d) δ 2.89 (hept, J=2.9 Hz, 1H), 1.52 (dh, J=13.7, 6.8 Hz, 1H), 1.18 (q, J=7.1 Hz, 2H), 0.86 (d, J=6.8 Hz, 6H), 0.72 (t, J=7.1 Hz, 2H), 0.29-0.18 (m, 246H).

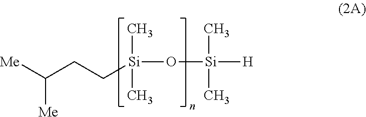

Vinyltrimethoxysilane (0.3 g) and 1,3-bistrifluoromethylbenzene (10 g) were added to the Compound 2A (3.0 g), and stirred. Thereafter, a toluene solution (platinum content rate: 3% by mass, 0.1 g) of platinum/1,3-divinyl-1, 1,3,3-tetramethyldisiloxane complex and aniline (0.1 g) were added, and stirred at 40° C. for 24 hours. The solvent was distilled off under reduced pressure to provide 3.1 g of a Compound 2B. The structure of the Compound 2B was confirmed from the following NMR data. In the Compound 2B, the average value of n was 40.

¹H-NMR (500 MHz, Chloroform-d) δ 3.57 (s, 9H), 1.52 (dh, J=13.7, 6.8 Hz, 1H), 1.18 (q, J=7.1 Hz, 2H), 0.86 (d, J=7.0 Hz, 8H), 0.73 (td, J=7.1, 3.9 Hz, 4H), 0.24-0.12 (m, 246H).

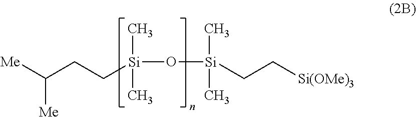

### [Synthesis of Compound 3A]

2,4,6,8-Tetramethyl -2,4,6,8-tetravinylcyclotetrasiloxane (2.0 g) and 1,3-bistrifluoromethylbenzene (10 g) were added to the Compound 1A (3.0 g), and stirred. Thereafter, a toluene solution (platinum content rate: 3% by mass, 0.1 g) of platinum/1,3-divinyl-1,1,3,3-tetramethyldisiloxane complex and aniline (0.1 g) were added, and stirred at 40° C. for 24 hours, and then the volatile components were distilled off under reduced pressure. Thereafter, vinyltrimethoxysilane (1.2 g) and 1,3-bistrifluoromethylbenzene (10 g) were added and stirred, and then, a toluene solution of platinum/1,3-divinyl-1,1,3,3-tetramethyldisiloxane complex (platinum content rate 3% by mass, 0.1 g) and aniline (0.1 g) were added again, and stirred at 40° C. for 24 hours. The solvent was distilled off under reduced pressure to provide 3.3 g of a Compound 3A. The structure of the Compound 3A was confirmed from the following NMR data. In the Compound 3A, the average value of n was 40.

¹H-NMR (500 MHz, Chloroform-d) δ 3.58 (d, J=4.6 Hz, 27H), 1.42-1.16 (m, 40H), 0.92-0.81 (m, 3H), 0.71-0.07 (m, 264H).

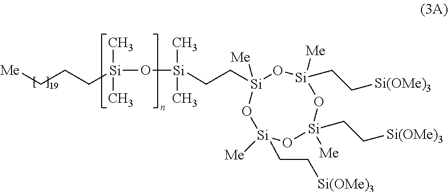

### [Synthesis of Compound 4A]

A Compound 4A was obtained according to the method described in Examples of JP 2017-201010A. The average value of n2 was 24.

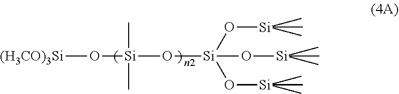

### [Synthesis of Compound 5A]

A Compound 5A was obtained according to the method described in Example 1 of JP 2017-119849 A.

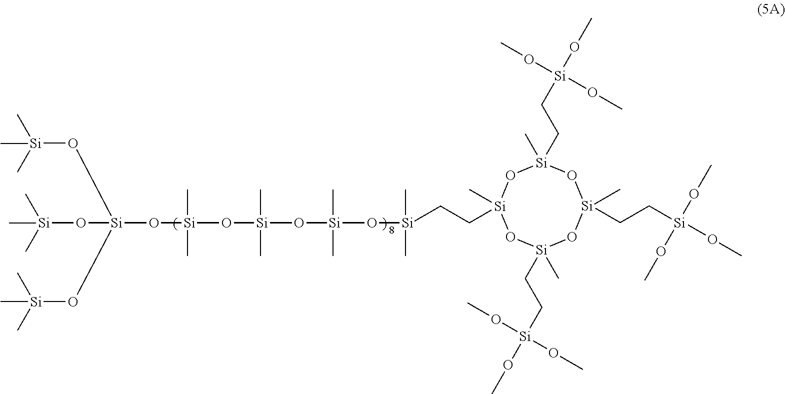

Then, a substrate was subjected to a surface treatment with the Compounds 1B, 2B, 3A, 4A, and 5A. As a surface treatment method, a dry coating method was used. As the substrate, chemically strengthened glass was used.

### <Dry Coating Method>

The dry coating was performed using a vacuum deposition apparatus (product name “VTR-350M”, manufactured by ULVAC, Inc.). A 20% by mass ethyl acetate solution (0.5 g) of each compound was filled in a molybdenum boat in a vacuum vapor deposition apparatus, and the inside of the vacuum vapor deposition apparatus was evacuated so that the pressure thereof was 1×10⁻³ Pa or less. The boat was heated at a temperature increase rate of 10° C./min or less, and when the vapor deposition rate by the crystal oscillation film thickness meter exceeded 1 nm/see, the shutter was opened to start film formation on the surface of the substrate. When the film thickness reached about 50 nm, the shutter was closed to finish the film formation on the surface of the substrate. The substrate on which the compound was deposited was heat-treated at 150° C. for 30 minutes to provide an article having a surface treatment layer on the surface of the substrate.

The article obtained by the dry coating method was evaluated for water repellency and abrasion resistance. The evaluation method is as follows.

### <Water Repellency>

About 2 μL of distilled water was dropped on the surface treatment layer of the article, and the initial water contact angle was measured using a contact angle measuring apparatus (product name “DM-500”, manufactured by Kyowa Interface Science Co., Ltd.). The measurement was performed at five locations on the surface treatment layer, and the average value was calculated. The water contact angle was calculated by the 20 method. The evaluation method is as follows. A and B are levels at which there is no problem in practical use.
A: water contact angle is 1100 or more.
B: water contact angle is 108° or more and less than 110°.
C: water contact angle is less than 108°.

### <Abrasion Resistance>

In accordance with JIS L0849:2013 (corresponding ISO: 105-X12:2001), a steel wool bonster (#0000) was reciprocated 10,000 times at a pressure of 98.07 kPa and a speed of 320 cm/min with a reciprocating traverse tester (manufactured by KNT Co., Ltd.), and then the water contact angle after the friction test was measured for the surface treatment layer of the article. The method of measuring the water contact angle after the friction test is the same as the initial method of measuring the water contact angle in the method of evaluating water repellency. The abrasion resistance was evaluated based on the degree of reduction in the water contact angle by the friction test. It can be said that as the reduction degree of the water contact angle decreases, the abrasion resistance is more excellent. The evaluation method is as follows. A and B are levels at which there is no problem in practical use.

Reduction degree of water contact angle=(initial water contact angle)−(water contact angle after friction test)
A: degree of decrease in water contact angle was 5° or less.
B: degree of decrease in water contact angle was more than 5° and 10° or less.
C: degree of decrease in water contact angle was more than 10°.

The evaluation results are shown in Table 1. In Table 1, the compound is described as “Y” when containing an alkyl group having two or more carbon atoms, an organopolysiloxane residue, or a reactive silyl group, and is described as “N” when not containing the alkyl group, the organopolysiloxane residue, or the reactive silyl group.

Examples 1 to 3 are examples, and Examples 4 and 5 are comparative examples.

TABLE 1

| | Compound | | | | Evaluation | |
|---|---|---|---|---|---|---|
| | | Alkyl | Organopolysiloxane | Reactive | Water | Abrasion |
| | Type | group | residue | silyl group | repellency | resistance |
| Example 1 | Compound 1B | Y | Y | Y | A | B |
| Example 2 | Compound 2B | Y | Y | Y | B | B |
| Example 3 | Compound 3A | Y | Y | Y | A | A |
| Example 4 | Compound 4A | N | Y | Y | B | C |
| Example 5 | Compound 5A | N | Y | Y | B | C |

As shown in Table 1, it has been found that the compounds of Examples 1 to 3 contain alkyl groups having two or more carbon atoms, organopolysiloxane residues, and reactive silyl groups, and thus surface treatment layers excellent in water repellency and abrasion resistance can be formed.

On the other hand, it has been found that the compounds of Example 4 and Example 5 did not contain alkyl groups having two or more carbon atoms and were poor in abrasion resistance.

### [Synthesis of Compound 11B]

To carboxylic acid-terminated polydimethylsiloxane (the average value of n is 16, and the number of carbon atoms of the alkylene group linked to the carboxylic acid is 10, product number: MCR-B12, manufactured by Gelest, Inc.) (5.0 g), methylene chloride (20 mL) and oxalyl chloride (1.3 g) were added, and stirred at 25° C. for 2 hours. The solvent and low-boiling components were distilled off under reduced pressure, and then 2,2-diallylpenta-4-ene-1-amine (1.2 g), methylene chloride (20 mL), and triethylamine (0.70 g) were added, and stirred at 25° C. for 2 hours. The solvent and the low-boiling component were distilled off under reduced pressure, and then flash column chromatography (developing solvent: hexane/ethyl acetate) with silica gel was performed to provide 2.2 g of a Compound 11A. The structure of the Compound 11A was confirmed from the following NMR data. In the Compound 11A, the average value of n was 16.

¹H-NMR (400 MHz, Chloroform-d) δ 5.85 (ddt, J=16.6, 10.5, 7.4 Hz, 3H), 5.48 (s, 1H), 5.17-4.98 (m, 6H), 3.18 (d, J=6.4 Hz, 2H), 2.19-2.09 (m, 2H), 2.01 (dt, J=7.4, 1.2 Hz, 6H), 1.54 (m, 2H), 1.40-1.06 (m, 18H), 0.94-0.76 (m, 3H), 0.59-0.38 (m, 4H), 0.05(s, 102H).

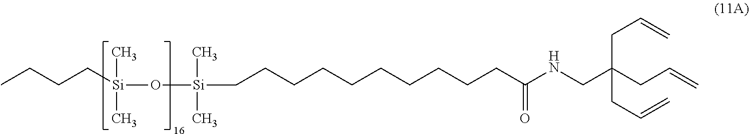

The Compound 11A (1.0 g) was dissolved in 1,3-bistrifluoromethylbenzene (2.0 mL), and a toluene solution of platinum/1,3-divinyl-1,1,3,3-tetramethyldisiloxane complex (platinum content rate: 3% by mass, 15 μL), aniline (4.8 μL), and trimethoxysilane (0.31 g) were added, then stirred at 40° C. for 2 hours, and then the solvent was distilled off under reduced pressure to provide 1.1 g of a Compound 11B. The structure of the Compound 11B was confirmed from the following NMR data. In the Compound 11B, the average value of n was 16.

¹H-NMR (400 MHz, Chloroform-d) δ 5.65 (t, J=6.1 Hz, 1H), 3.49 (s, 27H), 3.04 (d, J=6.2 Hz, 2H), 2.18-2.04 (m, 2H), 1.37-0.95 (m, 32H), 0.95-0.72 (m, 3H), 0.69-0.36 (m, 10H), -0.07 (s, 102H).

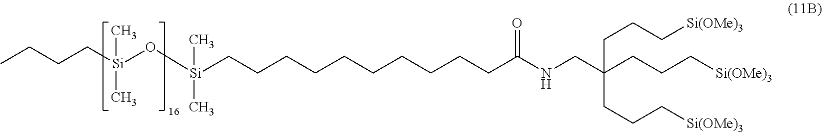

### [Synthesis of Compound 12A]

In the same manner as the Compound 11B except that the carboxylic acid-terminated polydimethylsiloxane was changed to a compound in which the average value of n was 168 and the carbon number of the alkylene group connected to the carboxylic acid was 10, 1.0 g of the Compound 12A was obtained. The structure of the Compound 12A was confirmed from the following NMR data. In the Compound 12A, the average value of n was 168.

The carboxylic acid-terminated polydimethylsiloxane was synthesized in the same manner as in a later-described Compound 21C. The average value of n was controlled by changing the amount of hexamethylcyclotrisiloxane added.

¹H-NMR (400 MHz, Chloroform-d) δ 5.42-5.27 (m, 1H), 3.57 (s, 27H), 3.12 (d, J=6.2 Hz, 2H), 2.16 (t, J=7.7 Hz, 2H), 1.63 (s, 2H), 1.46-1.14 (m, 30H), 0.92-0.84 (m, 3H), 0.69-0.46 (m, 10H), 0.07 (s, 1014H).

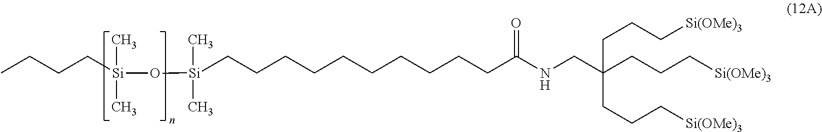

### [Synthesis of Compound 13A]

A Compound 13A was obtained in the same manner as the Compound 11B except that the carboxylic acid-terminated polydimethylsiloxane was changed to a compound in which the average value of n was 30 and the carbon number of the alkylene group connected to the carboxylic acid was 4. The structure of the Compound 13A was confirmed from the following NMR data. In the Compound 13A, the average value of n was 30.

The carboxylic acid-terminated polydimethylsiloxane was synthesized in the same manner as in a later-described Compound 21C. The average value of n was controlled by changing the amount of hexamethylcyclotrisiloxane added.

¹H-NMR (400 MHz, Chloroform-d) δ 5.70 (s, 1H), 3.57 (s, 27H), 3.12 (d, J=6.2 Hz, 2H), 2.16 (t, J=7.7 Hz, 2H), 1.63-1.14 (m, 20H), 0.92-0.84 (m, 3H), 0.69-0.46 (m, 10H), 0.07 (s, 186H).

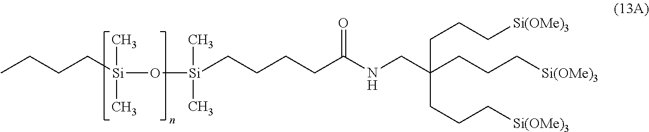

### [Synthesis of Compound 14A]

In the same manner as the Compound 11B except that the carboxylic acid-terminated polydimethylsiloxane was changed to a compound in which the average value of n was 183 and the carbon number of the alkylene group connected to the carboxylic acid was 4, 1.0 g of a Compound 14A was obtained. The structure of the Compound 14A was confirmed from the following NMR data. In the Compound 14A, the average value of n was 183.

The carboxylic acid-terminated polydimethylsiloxane was synthesized in the same manner as in a later-described Compound 21C. The average value of n was controlled by changing the amount of hexamethylcyclotrisiloxane added.

¹H-NMR (400 MHz, Chloroform-d) δ 5.70 (s, 1H), 3.57 (s, 27H), 3.12 (d, J=6.2 Hz, 2H), 2.16 (t, J=7.7 Hz, 2H), 1.63-1.14 (m, 20H), 0.92-0.84 (m, 3H), 0.69-0.46 (m, 10H), 0.07 (s, 1104H).

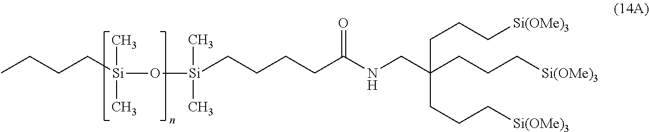

### [Synthesis of Compound 15F]

A THF solution (0.80M) of a Compound 15A was obtained according to the method described in WO 2021/054413.

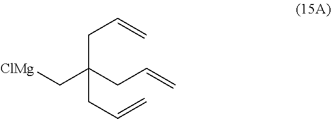

Under a nitrogen atmosphere, to 8-bromo-1-octanol (3.0 g), tetrahydrofuran (hereinafter, referred to as “THF”, 20 mL), a THF solution of the Compound 15A (0.80M) (40 mL), and copper (II) chloride (0.10 g) were added, and stirred at 60° C. for 2 hours. Low-boiling components were distilled off under reduced pressure, then hydrochloric acid was added, and extracted with methylene chloride. Low-boiling point components were distilled off again under reduced pressure, and then flash column chromatography (developing solvent: hexane/ethyl acetate) with silica gel was performed to provide 3.0 g of a Compound 15B. The structure of the Compound 15B was confirmed from the following NMR data.

¹H-NMR (400 MHz, Chloroform-d) δ 5.80 (ddt, J=16.6, 10.5, 7.4 Hz, 3H), 5.18-4.91 (m, 6H), 3.64 (q, J=6.5 Hz, 2H), 2.06-1.91 (m, 6H), 1.61-1.49 (m, 2H), 1.49-1.07 (m, 14H).

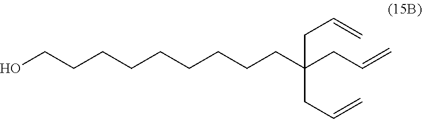 [SMILES: C=CCC(CC=C)(CC=C)CCCCCCCCCO]

Under a nitrogen atmosphere, methylene chloride (20 mL), methanesulfonyl chloride (2.5 g), and triethylamine (5.5 g) were added to the Compound 15B (3.0 g) and stirred at 25° C. for 2 hours. Hydrochloric acid was added, and extraction was performed with methylene chloride, and then low-boiling components were distilled off under reduced pressure. Thereafter, DMF (20 mL) and sodium azide (0.85 g) were added to the reaction product, and stirred at 80° C. for 2 hours. Water was added, extraction was performed with hexane, and then low-boiling components were distilled off under reduced pressure. Flash column chromatography (developing solvent: hexane/ethyl acetate) with silica gel was performed to provide 2.2 g of a Compound 15C. The structure of the Compound 15C was confirmed from the following NMR data.

¹H-NMR (400 MHz, Chloroform-d) δ 5.78 (ddt, J=16.7, 10.5, 7.4 Hz, 3H), 5.12-4.91 (m, 6H), 3.24 (t, J=7.0 Hz, 2H), 1.96 (dt, J=7.4, 1.3 Hz, 6H), 1.65-1.52 (m, 2H), 1.43-1.03 (m, 14H).

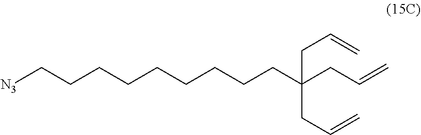 [SMILES: C=CCC(CC=C)(CC=C)CCCCCCCCCN=[N+]=[N-]]

Under a nitrogen atmosphere, THF (20 mL) and a THF solution (2.0M) (4.6 mL) of lithium aluminum hydride were added to the Compound 15C (0.70 g) and stirred at 25° C. for 16 hours. An aqueous solution of sodium hydroxide was added, the precipitated solid was filtered, and then low-boiling components were distilled off under reduced pressure. Flash column chromatography (developing solvent: methylene chloride/methanol) with silica gel was performed to provide 0.52 g of a Compound 15D. The structure of the Compound 15D was confirmed from the following NMR data.

¹H-NMR (400 MHz, Chloroform-d) δ 5.78 (ddt, J=16.6, 10.5, 7.4 Hz, 3H), 5.19-4.82 (m, 6H), 2.65 (t, J=7.0 Hz, 2H), 1.95 (dt, J=7.4, 1.3 Hz, 6H), 1.68-0.92 (m, 16H).

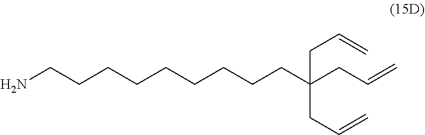 [SMILES: C=CCC(CC=C)(CC=C)CCCCCCCCCN]

To carboxylic acid-terminated polydimethylsiloxane (the average value of n is 16, and the number of carbon atoms of the alkylene group linked to the carboxylic acid is 10, product number: MCR-B12, manufactured by Gelest, Inc.) (1.0 g), methylene chloride (20 mL) and oxalyl chloride (1.3 g) were added, and stirred at 25° C. for 2 hours. The solvent and the low-boiling components were distilled off under reduced pressure, and then the Compound 15D (0.30 g), methylene chloride (20 mL), and triethylamine (0.70 g) were added, and stirred at 25° C. for 2 hours. The solvent and the low-boiling component were distilled off under reduced pressure, and then flash column chromatography (developing solvent: hexane/ethyl acetate) with silica gel was performed to provide 0.75 g of a Compound 15E. The structure of the Compound 15E was confirmed from the following NMR data. In the Compound 15E, the average value of n was 16.

¹H-NMR (400 MHz, Chloroform-d) δ 5.73 (ddt, J=16.7, 10.5, 7.4 Hz, 3H), 5.29 (s, 1H), 5.04-4.85 (m, 6H), 3.16 (td, J=7.3, 5.8 Hz, 2H), 2.14-2.01 (m, 2H), 1.90 (dt, J=7.4, 1.3 Hz, 6H), 1.61-1.34 (m, 4H), 1.33-0.98 (m, 32H), 0.94-0.69 (m, 3H), 0.45 (td, J=8.3, 7.8, 5.2 Hz, 4H), 0.13 (s, 78H).

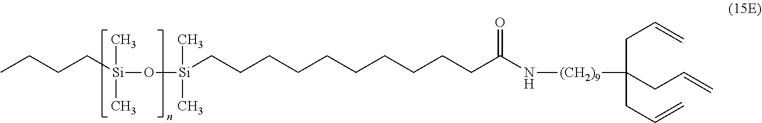

The Compound 15E (0.75 g) was dissolved in 1,3-bistrifluoromethylbenzene (2.0 mL), and a toluene solution of platinum/1,3-divinyl-1,1,3,3-tetramethyldisiloxane complex (platinum content rate: 3% by mass, 15 μL), aniline (4.8 μL), and trimethoxysilane (0.30 g) were added, then stirred at 40° C. for 2 hours, and then the solvent was distilled off under reduced pressure to provide 0.80 g of a Compound 15F. The structure of the Compound 15F was confirmed from the following NMR data. In the Compound 15F, the average value of n was 16.

¹H-NMR (400 MHz, Chloroform-d) δ 5.42-5.27 (m, 1H), 3.49 (s, 27H), 3.27-2.99 (m, 2H), 2.14-2.02 (m, 2H), 1.69-1.35 (m, 4H), 1.35-0.91 (m, 44H), 0.91-0.72 (m, 3H), 0.63-0.37 (m, 10H), 0.13 (s, 78H).

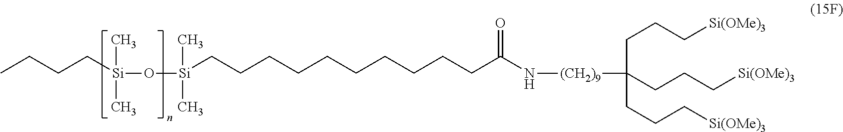

### [Synthesis of Compound 16D]

Under a nitrogen atmosphere, hydrobromic acid (20 mL) and hexane (20 mL) were added to 1,18-octadecanediol (2.5 g), and stirred at 70° C. for 2 hours. The solvent and the low-boiling components were distilled off under reduced pressure, then a THF solution (0.80M) (40 mL) of the Compound 15A and copper (II) chloride (0.10 g) were added, and stirred at 60° C. for 2 hours. Hydrochloric acid was added, and then extraction was performed with hexane. The low-boiling-point components were again distilled off under reduced pressure. Methanesulfonyl chloride (2.3 g), triethylamine (4.1 g), and methylene chloride (20 g) were added to the obtained compound, and stirred at 25° C. for 2 hours. Hydrochloric acid was added, and extraction was performed with methylene chloride, and then low-boiling components were distilled off under reduced pressure. DMF (20 mL) and sodium azide (1.5 g) were added to the obtained compound, and stirred at 80° C. for 2 hours.

Water was added, extraction was performed with hexane, and then low-boiling components were distilled off under reduced pressure. Flash column chromatography (developing solvent: hexane/ethyl acetate) with silica gel was performed to provide 1.8 g of a Compound 16A. The structure of the Compound 16A was confirmed from the following NMR data.

¹H-NMR (400 MHz, Chloroform-d) δ 5.80 (ddt, J=16.7, 10.5, 7.4 Hz, 3H), 5.16-4.89 (m, 6H), 3.25 (t, J=7.0 Hz, 2H), 1.98 (dt, J=7.4, 1.3 Hz, 6H), 1.68-1.56 (m, 2H), 1.26 (s, 34H).

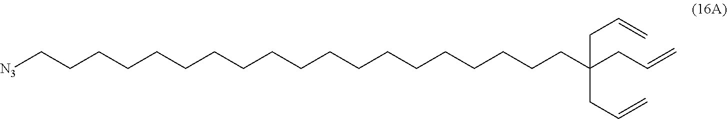 [SMILES: C=CCC(CC=C)(CC=C)CCCCCCCCCCCCCCCCCCCN=[N+]=[N-]]

Under a nitrogen atmosphere, THF (20 mL) and a THF solution (2.0 M) (6.4 mL) of lithium aluminum hydride were added to the Compound 16A (1.8 g), and stirred at 25° C. for 16 hours. An aqueous solution of sodium hydroxide was added, the precipitated solid was filtered, and then low-boiling components were distilled off under reduced pressure. Flash column chromatography (developing solvent: methylene chloride/methanol) with silica gel was performed to provide 1.52 g of a Compound 16B. The structure of the Compound 16B was confirmed from the following NMR data.

¹H-NMR (400 MHz, Chloroform-d) δ 5.80 (ddt, J=16.6, 10.6, 7.4 Hz, 3H), 5.12-4.93 (m, 6H), 2.79-2.55 (m, 2H), 1.98 (dt, J=7.3, 1.3 Hz, 6H), 1.26 (s, 36H).

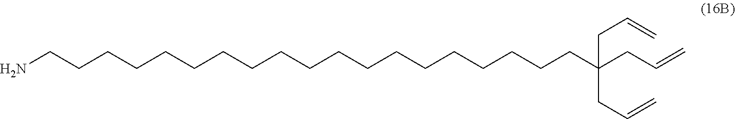 [SMILES: C=CCC(CC=C)(CC=C)CCCCCCCCCCCCCCCCCCCN]

Under a nitrogen atmosphere, methylene chloride (20 mL) and oxalyl chloride (1.3 g) were added to carboxylic acid-terminated polydimethylsiloxane (the average value of n is 10, and the number of carbon atoms of the alkylene group linked to the carboxylic acid is 10) (1.0 g), and stirred at 25° C. for 2 hours. The solvent and the low-boiling components were distilled off under reduced pressure, and then the Compound 16B (0.40 g), methylene chloride (20 mL), and triethylamine (0.70 g) were added, and stirred at 25° C. for 2 hours. The solvent and the low-boiling component were distilled off under reduced pressure, and then flash column chromatography (developing solvent: hexane/ethyl acetate) with silica gel was performed to provide 0.72 g of a Compound 16C. The structure of the Compound 16C was confirmed from the following NMR data. In the Compound 16C, the average value of n was 10.

The carboxylic acid-terminated polydimethylsiloxane was synthesized in the same manner as in a later-described Compound 21C. The average value of n was controlled by changing the amount of hexamethylcyclotrisiloxane added.

¹H-NMR (400 MHz, Chloroform-d) δ 5.73 (ddt, J=16.6, 10.5, 7.4 Hz, 3H), 5.29 (s, 1H), 5.05-4.77 (m, 6H), 3.16 (q, J=6.7 Hz, 2H), 2.07 (t, J=7.7 Hz, 2H), 1.90 (dt, J=7.4, 1.3 Hz, 6H), 1.67-0.93 (m, 56H), 0.93-0.71 (m, 3H), 0.53-0.34 (m, 4H), 0.05 (s, 66H).

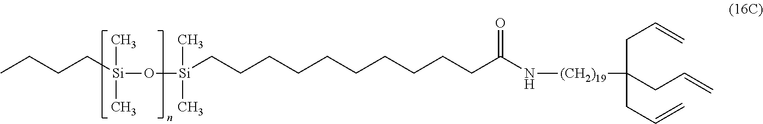

The Compound 16C (0.72 g) was dissolved in 1,3-bistrifluoromethylbenzene (2.0 mL), and a toluene solution of platinum/1,3-divinyl-1,1,3,3-tetramethyldisiloxane complex (platinum content rate: 3% by mass, 15 μL), aniline (4.8 μL), and trimethoxysilane (0.30 g) were added, then stirred at 40° C. for 2 hours, and then the solvent was distilled off under reduced pressure to provide 0.75 g of a Compound 16D. The structure of the Compound 16D was confirmed from the following NMR data. In the Compound 16D, the average value of n was 10.

¹H-NMR (400 MHz, Chloroform-d) δ 5.30 (s, 1H), 3.49 (s, 27H), 3.16 (q, J=6.7 Hz, 2H), 2.07 (t, J=7.7 Hz, 2H), 1.66-0.88 (m, 68H), 0.81 (td, J=6.3, 5.6, 1.8 Hz, 3H), 0.61-0.36 (m, 10H),−0.07 (s, 66H).

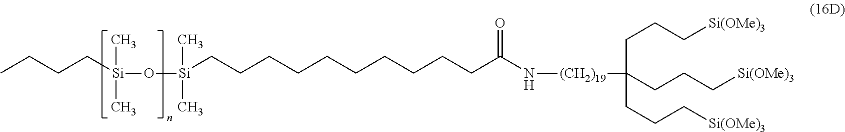

### [Synthesis of Compound 21E]

Under a nitrogen atmosphere, A xylene solution of platinum/1,3-divinyl-1,1,3,3-tetramethyldisiloxane complex (platinum content rate: 3% by mass, 0.10 mL) was added to a mixture of benzyl undeca-10-enoate (4.4 g), toluene (5.0 mL), and chlorodimethylsilane (2.7 mL), and stirred for 1 hour. The solvent and the low-boiling components were distilled off under reduced pressure to provide 5.9 g of a Compound 21A. The structure of the Compound 21A was confirmed from the following NMR data.

¹H-NMR (400 MHz, Chloroform-d) δ 7.42-7.32 (m, 5H), 5.14 (s, 2H), 1.73-1.59 (m, 2H), 1.51-1.20 (m, 16H), 0.89-0.79 (m, 2H), 0.43 (s, 6H).

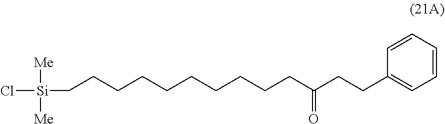 [SMILES: C[Si](C)(Cl)CCCCCCCCCCC(=O)CCc1ccccc1]

Under a nitrogen atmosphere, THF (20 mL) was added to a three-necked flask, cooled to 0° C., and a hexane solution of n-BuLi (1.6M, 5.0 mL) was added dropwise thereto. A THE solution (1.0 M, 24 mL) of hexamethylcyclotrisiloxane was added dropwise, and stirred for 5 hours. Thereafter, the Compound 21A (5.9 g) was added, and stirred for 5 hours. Low-boiling components were distilled off under reduced pressure, hexane and ion-exchanged water were sequentially added to the reaction solution, extraction was performed with hexane, and the organic layer was washed with water and saturated saline, and drying was performed over magnesium sulfate. Solid was filtered, the solvent and the low-boiling component were distilled off under reduced pressure, and the solid was washed with methanol to provide 3.2 g of a Compound 21B. The structure of the Compound 21B was confirmed from the following NMR data. In the Compound 21B, the average value of n was 12.

¹H-NMR (400 MHz, Chloroform-d) δ 7.43-7.28 (m, 5H), 5.11 (s, 2H), 2.35 (t, J=7.6 Hz, 2H), 1.71-1.53 (m, 4H), 1.38-1.16 (m, 16H), 0.88 (t, J=6.7 Hz, 3H), 0.58-0.47 (m, 4H), 0.27-0.15 (m, 78H).

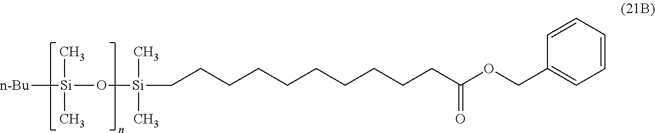

A mixture of the Compound 21B (3.2 g), 10% palladium-carbon (50% water content, 320 mg), and THF (15 mL) was stirred under a hydrogen atmosphere at 25° C. for 4 hours. The insoluble matter was filtered off, and the solvent of the filtrate was distilled off under reduced pressure to provide 2.9 g of a crude product of a Compound 21C.

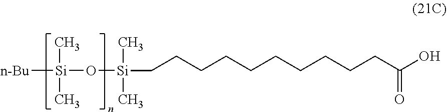

The crude product of the Compound 21C (1.5 g), 2-(undec-10-en-1-yl)tridec-12-en-1-amine (660 mg), and triethylamine (0.70 mL) were dissolved in THF (30 mL), and an ethyl acetate solution of 1-propanephosphonic anhydride (50% by mass, 1.5 mL) was added at 25° C., and then stirred at 25° C. for 16 hours. Ion exchanged water was sequentially added to the reaction solution, and extraction was performed with ethyl acetate, the organic layer was washed with 2N hydrochloric acid, saturated sodium bicarbonate solution, and saturated saline, and drying was performed over magnesium sulfate. The solvent and the low-boiling components were distilled off under reduced pressure, and flash column chromatography (developing solvent: hexane/ethyl acetate) with silica gel was performed to provide 1.3 g of a Compound 21D. The structure of the Compound 21D was confirmed from the following NMR data. In the Compound 21D, the average value of n was 12.

¹H-NMR (400 MHz, Chloroform-d) δ 5.81 (ddt, J=16.9, 10.2, 6.7 Hz, 2H), 5.42-5.27 (m, 1H), 5.05-4.85 (m, 4H), 3.19 (t, J=5.9 Hz, 2H), 2.16 (t, J=7.6 Hz, 2H), 2.09-1.98 (m, 4H), 1.63 (d, J=7.4 Hz, 3H), 1.27 (s, 50H), 0.97-0.84 (m, 3H), 0.60-0.47 (m, 4H), 0.25-0.15 (m, 78H).

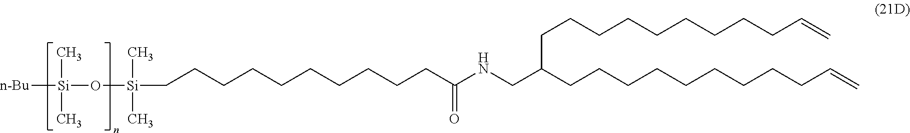

The Compound 21D (1.2 g) was dissolved in 1,3-bistrifluoromethylbenzene (1.4 mL), and a toluene solution of platinum/1,3-divinyl-1,1,3,3-tetramethyldisiloxane complex (platinum content rate: 3% by mass, 15 μL), aniline (4.8 μL), and trimethoxysilane (0.55 mL) were added, then stirred at 40° C. for 2 hours, and then the solvent was distilled off under reduced pressure to provide 1.3 g of a Compound 21E. The structure of the Compound 21E was confirmed from the following NMR data. In the Compound 21E, the average value of n was 12.

¹H-NMR (400 MHz, Chloroform-d) δ 5.36 (s, 1H), 3.57 (s, 18H), 3.18 (t, J=5.9 Hz, 2H), 2.16 (t, J=7.6 Hz, 2H), 1.69-1.56 (m, 3H), 1.52-1.11 (m, 58H), 0.92-0.84 (m, 3H), 0.69-0.59 (m, 4H), 0.58-0.46 (m, 4H), 0.26-0.17 (m, 78H).

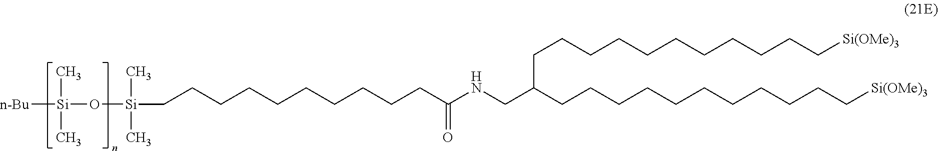

### [Synthesis of Compound 22B]

To carboxylic acid-terminated polydimethylsiloxane (the average value of n is 16, and the number of carbon atoms of the alkylene group linked to the carboxylic acid is 10, product number: MCR-B12, manufactured by Gelest, Inc.) (5.0 g), methylene chloride (20 mL) and oxalyl chloride (1.3 g) were added, and stirred at 25° C. for 2 hours. After the solvent and the low-boiling components were distilled off under reduced pressure, 2-(undec-10-ene-1-yl) tridec-12-ene-1-amine (2.3 g), methylene chloride (20 mL), and triethylamine (0.70 g) were added, and stirred at 25° C. for 2 hours. The solvent and the low-boiling component were distilled off under reduced pressure, and then flash column chromatography (developing solvent: hexane/ethyl acetate) with silica gel was performed to provide 2.8 g of a Compound 22A. The structure of the Compound 22A was confirmed from the following NMR data. In the Compound 22A, the average value of n was 16.

¹H-NMR (400 MHz, Chloroform-d) δ 5.74 (ddt, J=16.9, 10.2, 6.7 Hz, 2H), 5.24 (t, J=5.7 Hz, 1H), 5.04-4.76 (m, 4H), 3.11 (t, J=6.0 Hz, 2H), 2.17-2.04 (m, 2H), 2.04-1.87 (m, 4H), 1.61-1.51 (m, 2H), 1.47-1.04 (m, 51H), 0.93-0.75 (m, 3H), 0.55-0.36 (m, 4H), 0.07 (s, 102H).

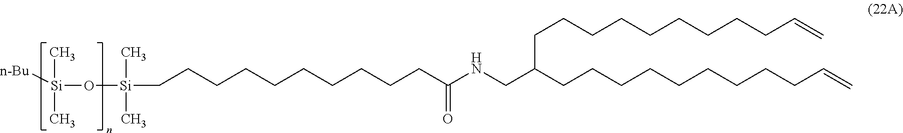

The Compound 22A (1.0 g) was dissolved in 1,3-bistrifluoromethylbenzene (2.0 mL), and a toluene solution of platinum/1,3-divinyl-1,1,3,3-tetramethyldisiloxane complex (platinum content rate: 3% by mass, 15 μL), aniline (4.8 μL), and trimethoxysilane (0.31 g) were added, then stirred at 40° C. for 2 hours, and then the solvent was distilled off under reduced pressure to provide 1.1 g of a Compound 22B. The structure of the Compound 22B was confirmed from the following NMR data. In the Compound 22B, the average value of n was 16.

¹H-NMR (400 MHz, Chloroform-d) δ 5.31-5.16 (m, 1H), 3.50 (s, 18H), 3.11 (t, J=6.0 Hz, 2H), 2.15-2.02 (m, 2H), 1.66-0.89 (m, 61H), 0.90-0.73 (m, 3H), 0.66-0.52 (m, 4H), 0.46 (ddd, J=12.6, 7.0, 3.2 Hz, 4H), 0.07 (s, 102H).

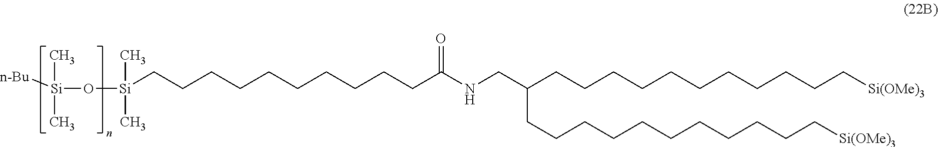

### [Synthesis of Compound 23A]

In the same manner as in 21E except that the carboxylic acid-terminated polydimethylsiloxane was changed to a compound in which the average value of n was 23 and the carbon number of the alkylene group connected to the carboxylic acid was 10, 0.40 g of the following Compound 23A was obtained. The structure of the Compound 23A was confirmed from the following NMR data. In the Compound 23A, the average value of n was 23.

The carboxylic acid-terminated polydimethylsiloxane was synthesized in the same manner as in the Compound 21C. The average value of n was controlled by changing the amount of hexamethylcyclotrisiloxane added.

¹H-NMR (400 MHz, Chloroform-d) δ 5.36 (s, 1H), 3.57 (s, 18H), 3.18 (t, J=5.9 Hz, 2H), 2.16 (t, J=7.6 Hz, 2H), 1.69-1.56 (m, 3H), 1.52-1.11 (m, 58H), 0.92-0.84 (m, 3H), 0.69-0.59 (m, 4H), 0.58-0.46 (m, 4H), 0.26-0.17 (m, 144H).

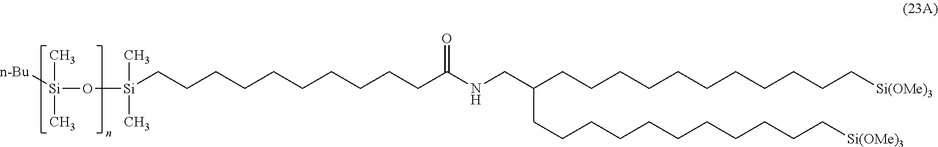

### [Synthesis of Compound 24A]

In the same manner as the Compound 21E except that the carboxylic acid-terminated polydimethylsiloxane was changed to a compound in which the average value of n was 38 and the carbon number of the alkylene group linking to the carboxylic acid was 10, 0.63 g of a Compound 24A was obtained. The structure of the Compound 24A was confirmed from the following NMR data. In the Compound 24A, the average value of n was 38.

The carboxylic acid-terminated polydimethylsiloxane was synthesized in the same manner as in the Compound 21C. The average value of n was controlled by changing the amount of hexamethylcyclotrisiloxane added.

¹H-NMR (400 MHz, Chloroform-d) δ 5.36 (s, 1H), 3.57 (s, 18H), 3.18 (t, J=5.9 Hz, 2H), 2.16 (t, J=7.6 Hz, 2H), 1.69-1.56 (m, 3H), 1.52-1.11 (m, 58H), 0.92-0.84 (m, 3H), 0.69-0.59 (m, 4H), 0.58-0.46 (m, 4H), 0.26-0.17 (m, 234H).

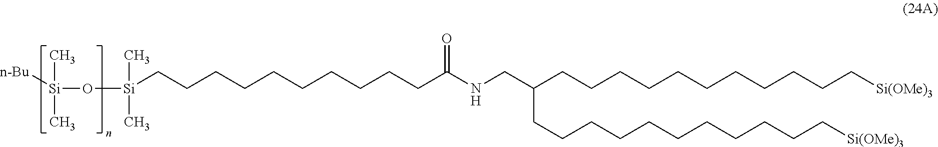

### [Synthesis of Compound 25A]

In the same manner as the Compound 21E except that the carboxylic acid-terminated polydimethylsiloxane was changed to a compound in which the average value of n was 48 and the carbon number of the alkylene group connected to the carboxylic acid was 10, 0.70 g of a Compound 25A was obtained. The structure of the Compound 25A was confirmed from the following NMR data. In the Compound 25A, the average value of n was 48.

The carboxylic acid-terminated polydimethylsiloxane was synthesized in the same manner as in the Compound 21C. The average value of n was controlled by changing the amount of hexamethylcyclotrisiloxane added.

¹H-NMR (400 MHz, Chloroform-d) δ 5.36 (s, 1H), 3.57 (s, 18H), 3.18 (t, J=5.9 Hz, 2H), 2.16 (t, J=7.6 Hz, 2H), 1.69-1.56 (m, 3H), 1.52-1.11 (m, 58H), 0.92-0.84 (m, 3H), 0.69-0.59 (m, 4H), 0.58-0.46 (m, 4H), 0.26-0.17 (m, 294H).

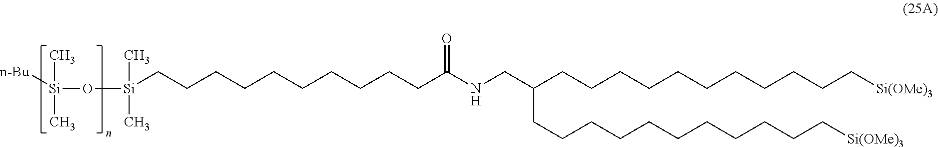

### [Synthesis of Compound 26A]

In the same manner as the Compound 21E except that the carboxylic acid-terminated polydimethylsiloxane was changed to a compound in which the average value of n was 120 and the carbon number of the alkylene group connected to the carboxylic acid was 10, 1.0 g of a Compound 26A was obtained. The structure of the Compound 26A was confirmed from the following NMR data. In the Compound 26A, the average value of n was 120.

The carboxylic acid-terminated polydimethylsiloxane was synthesized in the same manner as in the Compound 21C. The average value of n was controlled by changing the amount of hexamethylcyclotrisiloxane added.

¹H-NMR (400 MHz, Chloroform-d) δ 5.42-5.27 (m, 1H), 3.57 (s, 18H), 3.18 (t, J=5.9 Hz, 2H), 2.16 (t, J=7.6 Hz, 2H), 1.69-1.56 (m, 3H), 1.52-1.11 (m, 58H), 0.92-0.84 (m, 3H), 0.69-0.59 (m, 4H), 0.58-0.46 (m, 4H), 0.26-0.17 (m, 726H).

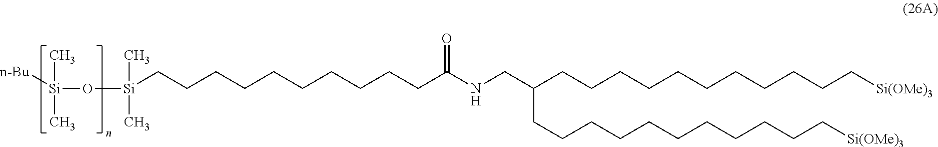

### [Synthesis of Compound 27D]

Under a nitrogen atmosphere, 2,3,4,5,6-pentafluorophenol (6.8 g), THF (42 mL), and triethylamine (5.1 g) were added to a 100 mL flask, and stirred at 25° C. To the reaction mixture, 10-undecenoyl chloride (5.0 g) was added dropwise and stirred for one hour. The reaction solution was filtered, and the solvent and low-boiling point components were distilled off under reduced pressure, and flash column chromatography (developing solvent: hexane/ethyl acetate) with silica gel was performed to provide 7.9 g of a Compound 27A. The structure of the Compound 27A was confirmed from the following NMR data.

¹H-NMR (400 MHz, Chloroform-d) δ 5.74(ddt, J=16.9, 10.2, 6.6 Hz, 1H), 5.05-4.77 (m, 2H), 2.59 (t, J=7.4 Hz, 2H), 1.97(q, J=7.1 Hz, 2H), 1.70(p, J=7.4 Hz, 2H), 1.42-1.08(m, 10H).

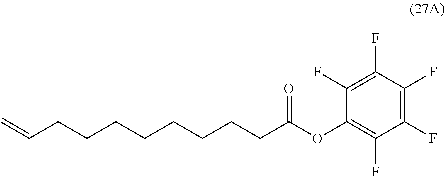 [SMILES: C=CCCCCCCCCC(=O)Oc1c(F)c(F)c(F)c(F)c1F]

Under a nitrogen atmosphere, a xylene solution (platinum content rate: 3% by mass, 0.10 mL) of platinum/1,3-divinyl-1,1,3,3-tetramethyldisiloxane complex was added to a mixture of the Compound 27A (5.6 g), THF (5.0 mL), and chlorodimethylsilane (2.3 g) in a 200 mL flask, and stirred for 2 hours. The solvent and the low-boiling components were distilled off under reduced pressure to provide 7.2 g of a Compound 27B. The structure of the Compound 27B was confirmed from the following NMR data.

¹H-NMR (400 MHz, Chloroform-d) δ 2.63 (t, J=7.4 Hz, 2H), 1.74(p, J=7.4 Hz,2H), 1.46-1.17 (m, 14H), 0.90-0.69 (m, 2H), 0.37 (s, 6H).

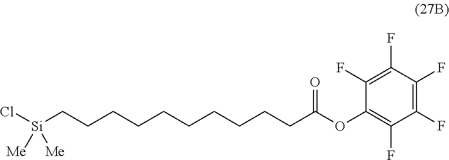 [SMILES: C[Si](C)(Cl)CCCCCCCCCCC(=O)Oc1c(F)c(F)c(F)c(F)c1F]

Under a nitrogen atmosphere, t-butyldimethylsilanol (2.5 g) and THF (92 mL) were added to a three-necked flask and stirred. Cooling was performed to 0° C., and a hexane solution of n-BuLi (1.6M, 11 mL) was added dropwise. A THF solution of hexamethylcyclotrisiloxane (1.1M, 19 mL) was added dropwise thereto, and a THF solution of hexamethylcyclotrisiloxane (1.1M, 100 mL) was further added dropwise thereto, then stirred for 7 hours. Thereafter, the Compound 27B (15 g) was added, and stirred for 1 hour, and then, 2-(undec-10-ene-1-yl)tridec-12-ene-1-amine (15 g) was added, and stirred for one hour. Hexane and ion-exchanged water were sequentially added to the reaction solution, and liquid separation was performed to separate an organic layer. The solvent and the low-boiling components were distilled off under reduced pressure, and then flash column chromatography (developing solvent: hexane/ethyl acetate) with silica gel was performed to provide 4.5 g of a Compound 27C. The structure of the Compound 27C was confirmed from the following NMR data. In the Compound 27C, the average value of n was 23.

¹H-NMR (400 MHz, Chloroform-d) δ 5.81 (ddt, J=16.9, 10.2, 6.7 Hz, 2H), 5.24 (t, J=5.7 Hz, 1H), 5.08-4.84 (m, 4H), 3.19 (t, J=6.0 Hz, 2H), 2.31-2.11 (m, 2H), 2.08-1.92 (m, 4H), 1.63 (t, J=7.3 Hz, 2H), 1.46-0.98 (m, 47H), 0.80 (s, 9H), 0.53 (t, J=7.7 Hz, 2H), 0.09 (s, 144H).

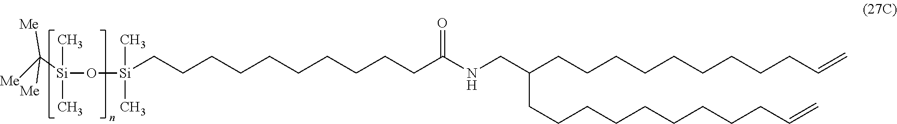

A toluene solution (platinum content rate: 3% by mass, 7.7 mg) of platinum/1,3-divinyl-1,1,3,3-tetramethyldisiloxane complex, aniline (1.2 mg), and trimethoxysilane (0.12 g) were added to the Compound 27C (1.0 g) dissolved in dichloromethane (1.5 g), and stirred at 25° C. for 2 hours. The solvent was distilled off under reduced pressure to provide 0.69 g of a Compound 27D. The structure of the Compound 27D was confirmed from the following NMR data. In the Compound 27D, the average value of n was 23.

¹H-NMR (400 MHz, Chloroform-d) δ 5.24 (t, J=5.7 Hz, 1H), 3.57 (s, 18H), 3.18 (t, J=6.0 Hz, 2H), 2.31-2.11 (m, 2H), 1.64-1.25 (m, 57H), 0.80 (s, 9H), 0.63-0.46 (m, 4H), 0.52 (t, J=7.7 Hz, 2H), 0.09 (s, 144H).

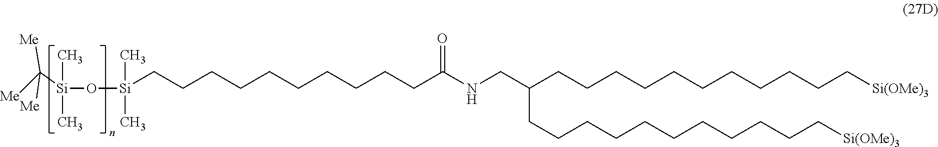

### [Synthesis of Compound 31D]

To a 50 mL vial, polydimethylsiloxane having a terminal SiH(Gelest, Inc., MCR-H21, 6.0 g), toluene (12 mL), homoallyl alcohol (0.17 g), and a xylene solution of platinum/1,3-divinyl-1,1,3,3-tetramethyldisiloxane complex (platinum content rate: 3% by mass, 0.16 g) were added, and stirred at 80° C. for 12 hours. After completion of the heating, the solvent and the low-boiling point components were distilled off under reduced pressure and washing was performed with methanol (30 mL). Flash column chromatography (developing solvent: hexane/ethyl acetate) with silica gel was performed to provide 2.0 g of a Compound 31A. In the Compound 31A, the average value of n was 39.

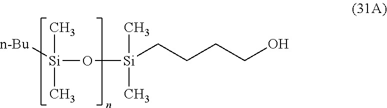

To a 50 mL vial, the Compound 31A (2.0 g), dichloromethane (2.0 g), pyridine (0.023 mL), and trifluoromethanesulfonic anhydride (0.078 mL) were added, and stirred at 25° C. for 15 hours. The solvent and the low-boiling point components were distilled off under reduced pressure, dissolved in dichloromethane, and subjected to a short column. The distillate was concentrated to provide 1.72 g of a Compound 31B. In the Compound 31B, the average value of n was 39.

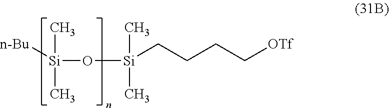

Under a nitrogen atmosphere, the Compound 31B (1.2 g), THF (2.0 mL), copper (II) chloride (0.012 g), and the Compound 15 A were added to a 50 mL Schrenck tube, and stirred at 25° C. for 5 minutes. The solvent and the low-boiling point components were distilled off under reduced pressure, dissolved in dichloromethane, and subjected to a short column. The distillate was concentrated, washed with methanol (10 mL), and concentrated again to provide 0.39 g of a Compound 31C. The structure of the Compound 31C was confirmed from the following NMR data. In the Compound 31C, the average value of n was 39.

¹H-NMR (400 MHz, Chloroform-d) δ 5.80 (ddt, J=16.5, 10.5, 7.4 Hz, 3H), 5.28-4.90 (m, 6H), 1.98 (dt, J=7.4, 1.2 Hz, 6H), 1.46-1.09 (m, 12H), 0.97-0.79 (m, 3H), 0.62-0.44 (m, 4H), 0.07 (s, 240H).

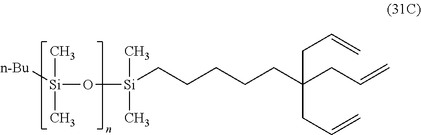

Axylene solution (platinum content rate: 3% by mass, 3.5 mg) of platinum/1,3-divinyl-1,1,3,3-tetramethyldisiloxane complex, aniline (0.50 mg), and trimethoxysilane (0.050 g) were added to the Compound 31C (0.20 g) dissolved in 1,3-trifluoromethylbenzene (0.20 g), and stirred at 25° C. for 2 hours. The solvent was distilled off under reduced pressure to provide 0.22 g of a Compound 31D. The structure of the Compound 31D was confirmed from the following NMR data. In the Compound 31D, the average value of n was 39.

¹H-NMR (400 MHz, Chloroform-d) δ 3.56 (s, 27H), 1.42-1.04 (m, 24H), 0.97-0.79 (m, 3H), 0.73-0.45 (m, 10H), 0.07 (s, 240H).

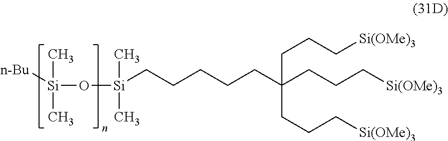

### [Synthesis of Compound 32B]

Under a nitrogen atmosphere, polydimethylsiloxane having a terminal vinyl group (Gelest, Inc., MCR-V21, 6.0 g), THF (6.0 mL), trichlorosilane (1.5 g), and a xylene solution of platinum/1,3-divinyl-1,1,3,3-tetramethyldisiloxane complex (platinum content rate: 3% by mass, 0.060 g) were added to a 50 mL Schlenk tube, and stirred at 25° C. for 62 hours. The solvent and low-boiling components were distilled off under reduced pressure, THF (6.0 mL) was added, and cooled to 4° C. A THF solution of allylmagnesium bromide was added thereto, the temperature was raised to 25° C., and stirring was performed for 2 hours. The solvent and the low-boiling point components were distilled off under reduced pressure and washing was performed with methanol (30 mL). Flash column chromatography (developing solvent: hexane/ethyl acetate) with silica gel was performed to provide 2.6 g of a Compound 32A. In the Compound 32A, the average value of n was 116.

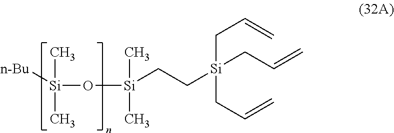

Axylene solution (platinum content rate: 3% by mass, 3.5 mg) of platinum/1,3-divinyl-1,1,3,3-tetramethyldisiloxane complex, aniline (0.50 mg), and trimethoxysilane (0.050 g) were added to the Compound 32A (0.50 g) dissolved in 1,3-trifluoromethylbenzene (0.50 g), and stirred at 25° C. for 2 hours. The solvent was distilled off under reduced pressure to provide 0.53 g of a Compound 32B. The structure of the Compound 32B was confirmed from the following NMR data. In the Compound 32B, the average value of n was 116.

¹H-NMR (400 MHz, Chloroform-d) δ 3.56 (s, 27H), 1.51-1.19 (m, 10H), 0.97-0.79 (m, 3H), 0.79-0.50 (m, 18H), 0.07 (s, 702H).

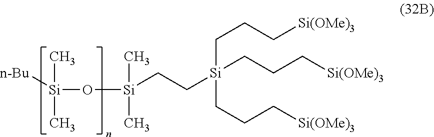

Then, the substrate was subjected to a surface treatment with the Compounds 11B, 12 A, 13 A, 14 A, 15 F, 16D, 21E, 22B, 23 A, 24 A, 25 A, 26 A, 27D, 31D, and 32B, and the Compounds 4 and 5. As a surface treatment method, a wet coating method was used. As the substrate, chemically strengthened glass was used.

### <Wet Coating Method>

30 g of silicon oxide was disposed as a vapor deposition source on a copper hearth in a vacuum vapor deposition apparatus (VTR-350M manufactured by ULVAC, Kiko Co., Ltd.). The substrate was disposed in the vacuum vapor deposition apparatus, and the inside of the vacuum vapor deposition apparatus was evacuated until the pressure reached 5×10⁻³ Pa or less. The hearth was heated to about 2,000° C., and silicon oxide was vacuum-deposited on the surface of the substrate. Thereby, a silicon oxide layer having a thickness of about 20 nm was formed on the substrate.

The substrate on which the silicon oxide layer was formed was placed on a sample stage of a spray coater (API-90RS manufactured by Apiros Co., Ltd.) so that the silicon oxide layer was on the surface. Then, 13 g of 0.2% by mass of a heptane solution of each compound was charged into a syringe in the spray coater, and spray-applied at an atomization pressure of 130 kPa, a distance between a nozzle and a sample surface of 50 mm, and a scanning speed of 300 mm/sec. Thereafter, the applied substrate was heat-treated at 140° C. for 30 minutes. As a result, an article having a surface treatment layer on the surface of the silicon oxide layer was obtained.

The article obtained by the wet coating method was evaluated for water repellency and abrasion resistance. The method of evaluating water repellency and abrasion resistance is as described above.

The evaluation results are shown in Table 2. In Table 2, the compound is described as “Y” when containing an alkyl group having two or more carbon atoms, an organopolysiloxane residue, or a reactive silyl group, and is described as “N” when not containing the alkyl group, the organopolysiloxane residue, or the reactive silyl group. In addition, n is the number of repetitions of the organopolysiloxane residue, n.

Examples 11 to 16, 21 to 27, 31, and 32 are examples, and Examples 33 and 34 are comparative examples.

TABLE 2

| | Compound | | | | | Evaluation | |
|---|---|---|---|---|---|---|---|
| | | | Alkyl | Organopolysiloxane | Reactive | Water | Abrasion |
| | Type | n | group | residue | silyl group | repellency | resistance |
| Example 11 | Compound 11B | 16 | Y | Y | Y | B | A |
| Example 12 | Compound 12A | 168 | Y | Y | Y | B | B |
| Example 13 | Compound 13A | 30 | Y | Y | Y | B | B |
| Example 14 | Compound 14A | 183 | Y | Y | Y | B | B |
| Example 15 | Compound 15F | 12 | Y | Y | Y | B | B |
| Example 16 | Compound 16D | 10 | Y | Y | Y | B | B |
| Example 21 | Compound 21E | 12 | Y | Y | Y | B | A |
| Example 22 | Compound 22B | 16 | Y | Y | Y | B | A |
| Example 23 | Compound 23A | 23 | Y | Y | Y | B | A |
| Example 24 | Compound 24A | 38 | Y | Y | Y | B | B |
| Example 25 | Compound 25A | 48 | Y | Y | Y | B | B |
| Example 26 | Compound 26A | 120 | Y | Y | Y | B | B |
| Example 27 | Compound 27D | 23 | Y | Y | Y | B | A |
| Example 31 | Compound 31D | 39 | Y | Y | Y | B | A |
| Example 32 | Compound 32B | 116 | Y | Y | Y | B | B |
| Example 33 | Compound 4A | | N | Y | Y | B | C |
| Example 34 | Compound 5A | | N | Y | Y | B | C |

As shown in Table 2, it has been found that the compounds of Examples 11 to 16, 21 to 27, 31 and 32 contain alkyl groups having two or more carbon atoms, organopolysiloxane residues, and reactive silyl groups, and thus surface treatment layers excellent in water repellency and abrasion resistance can be formed.

On the other hand, it has been found that the compounds of Examples 33 and 34 did not contain alkyl groups having two or more carbon atoms and were poor in abrasion resistance.

### INDUSTRIAL APPLICABILITY

The compound of the present disclosure is useful as a surface treatment agent. The surface treatment agent can be used, for example, for a substrate in a display device such as a touch panel display, an optical element, a semiconductor element, a building material, an automobile component, a nanoimprint technology, or the like. In addition, the surface treatment agent can be used for a body, a window glass (windshield, side glass, rear glass), a mirror, a bumper, and the like in transportation equipment such as a train, an automobile, a ship, and an airplane. Further, the surface treatment agent can be used for outdoor articles such as a building outer wall, a tent, a solar power generation module, a sound insulating plate, or concrete; a fishing net, an insect trap net, and a water tank. In addition, the surface treatment agent is used for a kitchen, a bathroom, a wash basin, a mirror, and a toilet peripheral component; chinaware such as a chandelier and a tile; various indoor facilities such as artificial marble and an air conditioner. In addition, the surface treatment agent can be used as an antifouling treatment for jigs, inner walls, pipes, and the like in a factory. In addition, the surface treatment agent can be used for goggles, glasses, helmets, pachinko, fibers, umbrellas, playing tools, and soccer balls. In addition, the surface treatment agent can be used as an adhesion inhibitor for various packaging materials such as food packaging materials, cosmetic packaging materials, and the inside of a pot. In addition, the surface treatment agent can be used for optical members such as a car navigation, a mobile phone, a smartphone, a digital camera, a digital video camera, a PDA, a portable audio player, a car audio, a game machine, a spectacle lens, a camera lens, a lens filter, sunglasses, and a medical instrument such as a stomach camera, a copying machine, a PC, a display (for example, a liquid crystal display, an organic EL display, a plasma display, or a touch panel display), a touch panel, a protective film, and an antireflection film.

The disclosure of Japanese Patent Application No. 2022-049062 filed on Mar. 24, 2022 is incorporated herein by reference in its entirety. Furthermore, all documents, patent applications, and technical standards described in this specification are incorporated herein by reference to the same extent as if each individual document, patent application, and technical standard were specifically and individually described to be incorporated by reference.

1. A compound, comprising: an alkyl group having two or more carbon atoms; an organopolysiloxane residue; and a reactive silyl group.

2. The compound according to claim 1, comprising two or more reactive silyl groups.

3. The compound according to claim 1, which is represented by the following Formula 1:
(T−Z)ₚA(Si(R¹)ₙL₃₋ₙ)_{q} Formula 1
wherein, in the Formula 1, T represents an alkyl group having two or more carbon atoms, Z represents a divalent organopolysiloxane residue, A represents a single bond or a (p+q)-valent linking group, each R¹ independently represents a monovalent hydrocarbon group, each L independently represents a hydrolyzable group or a hydroxyl group, n represents an integer from 0 to 2, and p and q each independently represent an integer of one or more.

4. The compound according to claim 3, wherein T represents an alkyl group having 4 to 22 carbon atoms.

5. The compound according to claim 3, wherein Z is represented by the following Formula B1: 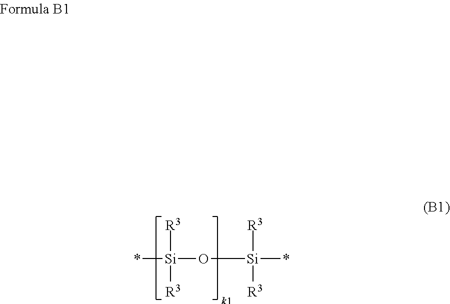
wherein, in the Formula B1, each R³ independently represents a hydrocarbon group, and k1 represents an integer of one or more.

6. The compound according to claim 5, wherein k1 is from 3 to 500 in the Formula B1.

7. A composition, comprising: the compound according to claim 1; and a liquid medium.

8. A surface treatment agent, comprising the compound according to claim 1.

9. A surface treatment agent, comprising: the compound according to claim 1; and a liquid medium.

10. The surface treatment agent according to claim 8, the surface treatment agent being used for an optical member.

11. A method of producing an article, the method comprising: subjecting a substrate to a surface treatment using the surface treatment agent according to claim 8 to produce an article having a surface treatment layer formed on the substrate.

12. An article, comprising: a substrate; and a surface treatment layer disposed on the substrate and surface-treated with the surface treatment agent according to claim 8.

13. The article according to claim 12, the article being an optical member.

14. The article according to claim 12, the article being a display or a touch panel.
